(19) United States
(12) Patent Application Publication
(10) Pub. No.: US 2016/0122139 A1
(43) Pub. Date: May 5, 2016

(54) CONTAINER TERMINAL

(71) Applicant: POLOTEC AS, Bergen (NO)

(72) Inventor: Einar PEDERSEN, Bergen (NO)

(21) Appl. No.: 14/891,777

(22) PCT Filed: Jun. 2, 2014
(86) PCT No.: PCT/NO2014/050087

§ 371 Date: Nov. 17, 2015

(30) Foreign Application Priority Data
May 31, 2013 (NO) 20130765

(51) Int. Cl. B65G 63/02; A47F 7/28; B65G 67/60; B65G 1/04; B65G 1/06

(52) U.S. Cl. CPC B65G 63/025; B65G 1/0492; B65G 1/06; B65G 67/603; A47F 7/28

(57) ABSTRACT

Container terminal comprising an automated modularized vertical storage system for storing ocean ISO containers on standardized cargo load platforms, the automated modularized vertical storage system comprising a number of modularized storage modules stacked vertically on top of each other forming a modularized block, wherein a number of modularized blocks are arranged side by side forming the automated modularized vertical storage system. An automated modularized vertical storage system for a container terminal is also described.

### INTRODUCTION

The present invention provides an automated container terminal, a modularized storage system for use in a container terminal, and a cargo trolley for use in the container terminal, wherein the cargo trolley is adapted for transporting cargo load platforms.

### BACKGROUND

Global ocean based logistics rely on dedicated container vessels carrying up to 20.000 TEU (twenty ft equivalent). Two twenty ft containers equal one 40 ft container (FEU). The container vessels loads and unloads their cargo in dedicated ports, which have dedicated terminals equipped with container cranes to offload/load the container vessels. The container terminal consists of a pier side, a land side and a Stack (storage area). On the land side there are facilities to load/offload and store containers before transfer to trucks and railcars.

The tremendous growth of global trade and the corresponding volumes of containers have made the terminals into chokepoints in the global logistics flow. The lack of available area behind the piers has forced the terminals to stack the containers on top of each other (block storage) using straddle carriers and cranes. This block storage area for the containers is called the Stack. For business reasons the terminals have to offer free demurrage of 5 days for imports and for exports, significantly impacting the required storage volumes. The combination of these factors results in a considerable number of terminal restacking/sorting operations to prepare/marshall cargo for a planned vessel arrival. The cargo needs to be loaded in accordance with a vessel loading plan that reflects a number of elements such as port of destination, below or above deck cargo, container weight, reefer box etc. resulting in a detailed terminal operating plan for each vessel arrival. Any short term changes in load plan or vessel delays causes significant negative “ripple down” effects. Similarly, import cargo needs to be placed in the Stack awaiting landside transportation placing additional demands in making containers available to land side transportation in a timely manner. As the terminal capacity utilization increases, the number of restacking operations increases until approaching saturation at approximately 80% of terminal design capacity.

The stack in a fully automated terminal is arranged in a number of blocks, each block containing a number of stacks of containers and having a land side and a pier side being served by two automated container cranes running on the same runway. This imposes a technical limitation on how many lifts this block can produce/hour and as a consequence, how many containers can be delivered to serve peak pier side or land side demand per hour.

Since terminal performance and economics is determined by the number of containers that crosses the pier/annum, the ability of the terminal Stack, but also terminal “hand off” of containers at the pier side to the vessel and at the land side to trucks and rails becomes essential to efficient terminal operations.

In conventional terminals, the issue of the land limitations has the same effect in terms of stacking containers on top of each other. However, using a different type of handling technology which relies on using much higher quantities of mobile handling equipment with a significantly higher degree of labor, can show higher productivity figures over the pier. However, the management of such a massive amount of equipment, the resulting congestions issues, as well as area use issues, when combined with escalating labor costs, and the high annual maintenance cost and limited life span of mobile equipment, indicates a need for significant technology change also in these types of terminals.

### SUMMARY OF THE INVENTION

The invention provides a solution to the problems with the existing stacks in the state of the art container terminals.

In an aspect the invention provides a container terminal comprising:

an automated modularized vertical storage system for storing ocean ISO containers on standardized cargo load platforms, the automated modularized vertical storage system comprising a number of modularized storage modules stacked vertically on top of each other forming a modularized block, wherein a number of modularized blocks are arranged side by side forming the automated modularized vertical storage system.

In a further aspect the invention provides a container terminal comprising:
an automated modularized vertical storage system for storing ocean ISO containers on standardized cargo load platforms,
   the automated modularized vertical storage system comprising a number of modularized storage modules stacked vertically on top of each other forming a modularized block, wherein a number of modularized blocks are arranged side by side forming the automated modularized vertical storage system,
   wherein the ocean ISO containers are stored on standardized cargo load platforms in slots in the modularized storage system, wherein the slots are arranged transverse of a distribution lane, each slot providing at least one storage position in a horizontal direction and at least one storage position in a vertical direction,
   wherein a number of the slots are provided with roller conveyors providing random access storage in at least some of the slots of the modularized storage module for the cargo load platforms; and
a number of cargo trolleys for transport of cargo load platforms within the automated modularized vertical storage system, wherein each cargo trolley comprising a wheel arrangement enabling longitudinal and transversal movement of the cargo trolley, and a lifting platform for transporting and lifting a cargo load platform, wherein the lifting platform is provided with roller conveyors for transfer of cargo load platforms and containers to and from roller conveyors arranged in the slots in the modularized storage system.

In an embodiment each modularized storage module may comprise a plurality of modularized vertical columns having a plurality of receiving means/receptacles adapted for engaging the cargo load platforms, wherein the cargo load platforms comprising locking means for engaging the receiving means/receptacles.

Further, a number of cargo trolleys for transport of cargo load platforms within the automated modularized vertical storage system may be provided; wherein at least a number of the cargo load platforms with ocean ISO containers may be locked to the vertical columns in positions enabling movement of the cargo trolleys under the number of cargo load platforms enabling transfer of cargo trolleys inside the modularized storage system. The automated modularized vertical storage system may further comprising a maintenance and holding area for the cargo trolleys arranged adjacent to the automated modularized vertical storage system communicating with the automated modularized vertical storage system, enabling maintenance, storage, on demand supply of the cargo trolleys throughout the modularized storage system. A subsystem may further be provided for handling, storage and circulation of cargo load platforms, said subsystem comprising a number of magazines for cargo load platforms arranged adjacent to the automated modularized vertical storage system, and a transfer system for transfer of cargo load platforms between the magazines. The container terminal may in a further embodiment comprise at least one of: a number of truck docks communicating with a truck interface of the modularized storage system; and a number of railway tracks communicating with a railway interface of the modularized storage system. The container terminal may further comprise a pier side, and a number of vehicles connecting the automatic modularized vertical storage system to the pier side. The container terminal may further comprise a number of pier side ship to shore (STS) cranes for loading/unloading a cargo vessel. The pier side of the terminal may comprise a number of buffer areas arranged side by side for storing containers on cargo load platforms provided with foldable legs, the buffer areas are served by the vehicles serving the pier side, wherein said buffer areas are arranged mainly parallel with the pier side serving a number of cranes when loading/unloading containers onboard/off a cargo vessel, and wherein the buffer areas comprising a number of passages for the vehicles serving the pier side. The pier side may comprise a number of lanes for the vehicles serving the pier side enabling communication between the land side and the pier side, wherein the lanes are arranged encircling the buffer areas.

The modularized storage system may be connected to the truck interface and the railway interface, and wherein the modularized service floor comprising at least one infeed and at least one outfeed conveyor system for the at least one modularized elevator serving the modularized storage system, enabling communication between the modularized storage system and the pier side and the land side of the terminal.

In an embodiment the modularized container terminal may be prefabricated in modules enabling packaging and transport in ocean ISO containers.

In a further aspect the invention provides an automated modularized vertical storage system for a container terminal, the automated modularized vertical storage system comprising:
a number of modularized storage blocks, wherein each storage block is served by at least one modularized elevator, wherein each modularized storage block comprising:
   at least one modularized storage module for storing ocean ISO containers on standardized cargo load platforms, wherein the modularized storage module comprising a plurality of modularized vertical columns having a plurality of receiving means/receptacles adapted for engaging the cargo load platforms, wherein the plurality of receiving means/receptacles are arranged in a predefined vertical pattern along the modularized vertical columns corresponding to a number of storage positions for a number of containers stored on a number of cargo load platforms.

In an even further aspect the invention provides an automated modularized vertical storage system for a container terminal, the automated modularized vertical storage system comprising:
a number of modularized storage blocks, wherein each storage block is served by at least one modularized elevator, wherein each modularized storage block comprising:
   at least one modularized storage module for storing ocean ISO containers on standardized cargo load platforms in slots in the modularized storage module, wherein each slot providing at least one storage position in a horizontal direction and at least one storage position in a vertical direction, wherein the modularized storage module comprising a plurality of modularized vertical columns having a plurality of receiving means/receptacles adapted for engaging cargo load platforms, wherein the plurality of receiving means/receptacles are arranged in a predefined vertical pattern along the modularized vertical columns corresponding to a number of storage positions for a number of containers stored on a number of cargo load platforms, wherein a number of the receiving means/receptacles are provided with roller conveyors providing random access storage in at least some of the slots of the modularized storage module for the cargo load platforms; and
   a number of cargo trolleys for transport of cargo load platforms within the automated modularized vertical storage system, wherein each cargo trolley comprising a wheel arrangement enabling longitudinal and transversal movement of the cargo trolley, and a lifting platform for transporting a cargo load platform, wherein the lifting platform is provided with roller conveyors for transfer of cargo load platforms and containers to and from roller conveyors arranged in the modularized storage module.

The modularized storage modules may be vertically stackable on top of each other. The modularized vertical columns may be vertically extendable in modular steps, each modular step forming a level in the modularized storage block, each level comprising at least one distribution aisle serving the at least one modularized storage module; and the at least one modularized elevator comprising modularized vertical elevator columns extendable in modular steps, wherein a height of the modularized vertical elevator columns is adapted to a number of modularized storage modules stacked on top of each other. A first modularized storage volume may be arranged between two parallel distribution lanes, and wherein a second and a third modularized storage volume are arranged on an outside of the two parallel distribution lanes. The plurality of modularized vertical columns may define a number of slots, each slot providing at least one storage position in a horizontal direction and at least one storage position in a vertical direction. A number of slots may be provided with a number of roller conveyors for conveying cargo load platforms with containers to assigned storage positions in the slots. Each of the modularized elevators may be provided with at least one buffer area on each level, wherein the at least one buffer area is provided with conveyor means for infeed and outfeed of cargo load platforms. The number of storage blocks may be arranged side by side. The modularized storage system may further comprise at least one transverse pathway for cargo trolleys between the number of modularized storage blocks enabling deployment of cargo trolleys to any distribution aisle in any of the modularized storage blocks. The at least one transverse pathway may be provided by roller conveyors running through parallel slots in a level throughout the number of storage blocks. The height of each slot may correspond to at least a maximum lifting height of a cargo trolley adapted for transporting the cargo load platforms. The modularized storage system may further comprising a maintenance and holding area arranged adjacent to the modularized storage system for the cargo trolleys serving the modularized storage system. The modularized storage system may further comprise at least one distribution lane serving the slots, the at least one distribution lane is provided with modularized longitudinal rails for the cargo trolley serving the slots. The slots may be arranged transverse of the distribution lane and wherein each slot is provided with modularized rails transverse to the modularized longitudinal rails in the distribution lane adapted for side transfer of the cargo trolley and cargo load platforms into and out of the slot. The modularized storage system may further comprise modularized power supply rails for power supply to cargo trolleys serving the slots. The modularized vertical columns may be horizontally connected by modularized longitudinal beams and modularized transverse beams, wherein modularized longitudinal beams supporting modularized longitudinal rails in at least one distribution lane and the modularized transverse beams supporting transverse rails in the slots. A base size of each storage position in the horizontal direction in each slot and a base size of each cargo load platform may correspond to a base size of a FEU footprint, and wherein each cargo load platform may be provided with locking means for engaging the receiving means/receptacles enabling support of the cargo load platforms as close to the vertical modular columns as possible. The receiving means/receptacles may be provided with conical guides for positioning of the locking means.

In a further aspect the invention provides a cargo trolley for transporting a cargo load platform in a modularized storage system, the cargo trolley comprising:
a wheel arrangement enabling longitudinal and transversal movement of the cargo trolley,
a lifting platform for transporting the cargo load platform, wherein the lifting platform is provided with roller conveyors for transfer of cargo load platforms and containers to and from roller conveyors arranged in slots in the modularized storage system; and
a lifting mechanism for lifting and lowering the lifting platform.

The wheel arrangement may comprise a first set of a wheel arrangement for running in the longitudinal direction, and a second set of a wheel arrangement, wherein the second set of wheel arrangement is transversally arranged to the first set of wheel arrangements for transversal transfer of the cargo trolley.

In an embodiment the cargo trolley may further comprise a mechanical connector arranged in the lifting platform, the mechanical connector being provided with drive means adapted to fold or unfold legs on the underside of the cargo load platform, and an actuating mechanism arranged in the lifting platform for extending and retracting a locking mechanism located in the cargo load platform for engaging and disengaging the cargo load platform with the modularized vertical columns of the modularized storage system.

The present invention relates to the field of storage and handling of ocean ISO containers in a mechanized and automated container terminal that provides fast and efficient response to land side and pier side service requirements and may be adapted to demands that vary significantly over time. The terminal according to the invention solves the issues related to the significant challenges to the existing storage philosophies, and provides a flexible solution with a minimum of area use, where the equipment capacities is easily adaptable to rapid changes to operating plans needed in the operation of ocean container terminals. The technology may also be easily implemented in dry ports. The storage area with service floor and communications to a rail side and truck side, also provides a flexible storage structure that may be easily be set up and implemented on land based terminals.

The present invention changes the approach to the stack function by introducing a vertical type modularized storage system. The present invention may allow storage of up to 12 containers in the vertical, dramatically reducing the storage area required for the stack. The transport to land side and pier side load handling is optimized by means of an automated subsystem which communicates directly with the modularized storage system.

### BRIEF DESCRIPTION OF DRAWINGS

Example embodiments of the invention will now be described with reference to the followings drawings, where:

FIG. 1a shows an outline of a container terminal with a modularized storage system for storing containers according to an embodiment of the invention;

FIG. 1b shows a schematic view of stack to pier communication for the container terminal according to an embodiment of the invention;

FIG. 1c shows a ground service floor with a buffer system for an elevator dedicated to a block in the modularized storage system of the container terminal according to an embodiment of the invention;

FIG. 1d shows a rail interface of the ground service floor of the modularized storage system according to an embodiment of the invention;

FIG. 1e shows a truck interface of modularized storage system of the container terminal according to an embodiment of the invention;

FIG. 1f illustrates circulation of cargo load platforms between magazines of a ground floor of the modularized storage system, according to an embodiment of the invention;

FIG. 1g illustrates circulation of cargo load platforms between magazines on a first level of the modularized storage system according to an embodiment of the invention;

FIG. 1h illustrates a magazine for storage of cargo load platforms according to an embodiment of the invention;

FIG. 1i illustrates a mode with random access storage with roller conveyors and block stow mode according to an embodiment of the invention;

FIG. 1j illustrates circulation of cargo trolleys within the modularized storage system according to an embodiment of the invention;

FIG. 1k illustrates horizontal exchange of cargo trolleys between blocks in the modularized storage system according to an embodiment of the invention; and

FIG. 1l illustrates use of roller conveyors for infeed and outfeed buffers for the lift in a block in a modularized storage system according to an embodiment of the invention;

FIG. 1m shows an outline of an alternative embodiment of the container terminal where the modularized storage system is divided in two parts and provided with a central passageway between the two parts according to an embodiment of the invention;

FIG. 1n shows an outline of an alternative embodiment of a mezzanine floor of the modularized storage system of the alternative container terminal in FIG. 1m,

FIG. 1o shows an outline of an alternative embodiment of a ground service floor of the modularized storage system of the alternative container terminal in FIG. 1m;

FIG. 1p shows an outline of a pick up by and delivery station for shuttle carriers for the modularized storage system of the alternative container terminal in FIG. 1m;

FIG. 1q shows an outline of a top view of the storage floors of the modularized storage system in the alternative container terminal in FIG. 1m;

FIG. 1r is a side view of the modularized storage system in the alternative container terminal in FIG. 1m,

FIG. 1s is a side view of the location of a cargo elevator of the modularized storage system in the alternative container terminal in FIG. 1m;

FIG. 2a is view of a part of a modularized storage structure comprising vertical columns and beams for flexible storage of cargo according to an embodiment of the invention;

FIG. 2b is a detail of one receiving means for a locking means on a cargo load platform according to an embodiment of the invention;

FIG. 2c shows a side view of a conical receiving means for cargo load platforms according to an embodiment of the invention;

FIG. 2d shows details of an end of a transport trolley for use in the modularized storage structure shown in FIG. 2a according to an embodiment of the invention;

FIG. 3a shows a basic storage module in the container terminal from FIG. 1 according to an embodiment of the invention;

FIG. 3b shows a basic storage module from FIG. 3a with elevator according to an embodiment of the invention;

FIG. 3c shows two basic storage modules with elevator according to an embodiment of the invention;

FIG. 3d shows two horizontal basic storage modules and two vertical basic storage modules with elevator during an upgrade of the storage module according to an embodiment of the invention;

FIG. 3e shows two horizontal basic storage modules and two vertical basic storage modules with elevator after an upgrade of the storage module according to an embodiment of the invention;

FIG. 3f shows five horizontal basic storage modules and two vertical basic storage modules with elevator during an upgrade of the storage module according to an embodiment of the invention;

FIG. 3g shows five horizontal basic storage modules and two vertical basic storage modules with elevator after an upgrade of the storage module according to an embodiment of the invention;

FIG. 3h shows five horizontal basic storage modules and three vertical basic storage modules with elevator during an upgrade of the storage module according to an embodiment of the invention;

FIG. 3i shows five horizontal basic storage modules and three vertical basic storage modules with elevator after an upgrade of the storage module according to an embodiment of the invention;

FIG. 4 shows a modularized storage system in a container terminal constituted by six modularized blocks arranged side by side, according to an embodiment of the invention;

FIG. 5a is a schematic cross sectional view of a modularized storage structure with four storage levels, two distribution aisles with storage areas in the middle and on the sides for storing cargo on cargo load platforms according to an embodiment of the present invention;

FIG. 5b is a schematic side view of the modularized storage structure from FIG. 5a, illustrating placement of a container on a cargo load platform by the use of a transport trolley in a dedicated position within the storage structure according to an embodiment of the present invention;

FIG. 5c is a view from above of a level in the modularized structure from FIG. 5a showing two distribution lanes with storage areas in the middle and on the sides according to an embodiment of the present invention;

FIG. 6a is an enlarged view of an end of a cargo load platform showing details of a locking arrangement and an actuating arrangement for engaging the cargo load platform in the modularized storage structure according to an embodiment of the present invention;

FIG. 6b is a side view of the details of the locking arrangement from FIG. 6a according to an embodiment of the present invention;

FIG. 6c is view from above of the cargo load platform with container fixed to the modularized storage structure;

FIG. 6d is a side view of the cargo load platform with container fixed to the modularized storage structure;

FIG. 7a shows a cargo load platform with legs for storage of a container on the ground according to an embodiment of the present invention;

FIG. 7b is a view of the cargo load platform from FIG. 7a according to an embodiment of the present invention;

FIG. 7c shows the cargo load platform with container from FIG. 7a where the legs are about to be folded in according to an embodiment of the present invention;

FIG. 7d shows the cargo load platform with container from FIG. 7a where the legs are fully folded into the cargo load platform, according to an embodiment of the present invention;

FIGS. 7e-7h illustrates as a sequence of steps how a cargo trolley is moved sideways below the cargo load platform (FIG. 7e), the trolley lifting the load platform (FIG. 7f), connecting to the load platform and folding the legs on the load platform (FIG. 7g), and turning the wheels into the appropriate direction for further transport (FIG. 7h);

FIG. 8a is a schematic outline of a slot in a part of a modularized storage structure with modularized columns and modularized beams providing storage positions for containers stored on cargo load platforms according to an embodiment of the present invention;

FIG. 8b shows the slot from FIG. 8a upon arrival of a container on a cargo load platform transported by a cargo trolley according to an embodiment of the present invention;

FIG. 8c shows arranging of the cargo load platform with container in a predefined storage position in the slot by a scissor lift system of the cargo trolley according to an embodiment of the present invention; and

FIG. 8d shows the slot with containers on cargo load platforms fixed to the storage structure according to an embodiment of the present invention.

### DETAILED DESCRIPTION

The present invention will be described with reference to the drawings. The same reference numerals are used for the same of similar features in all the drawings and throughout the description.

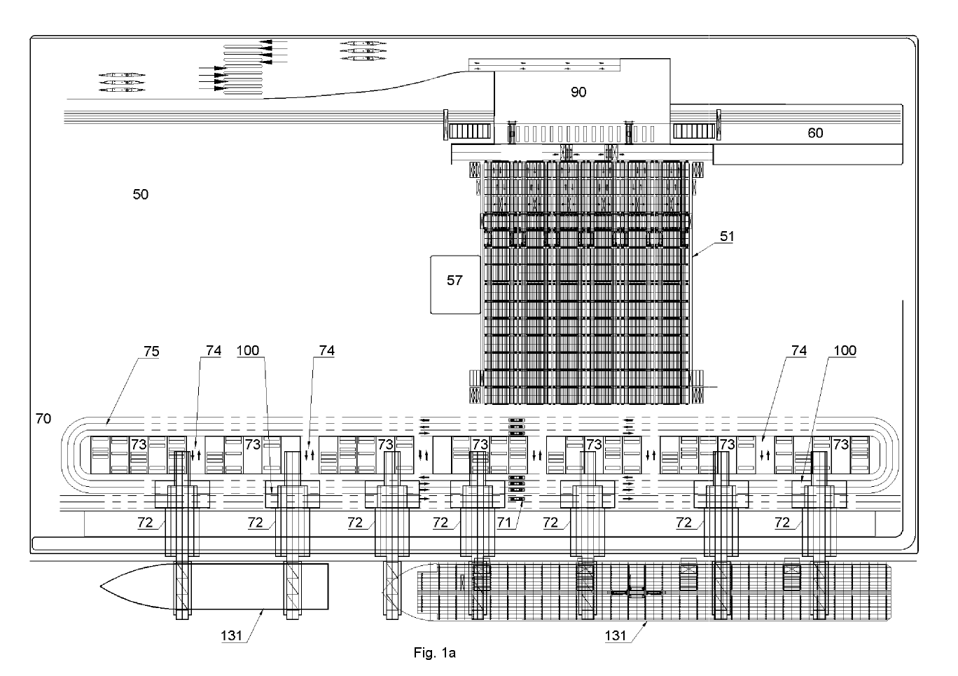

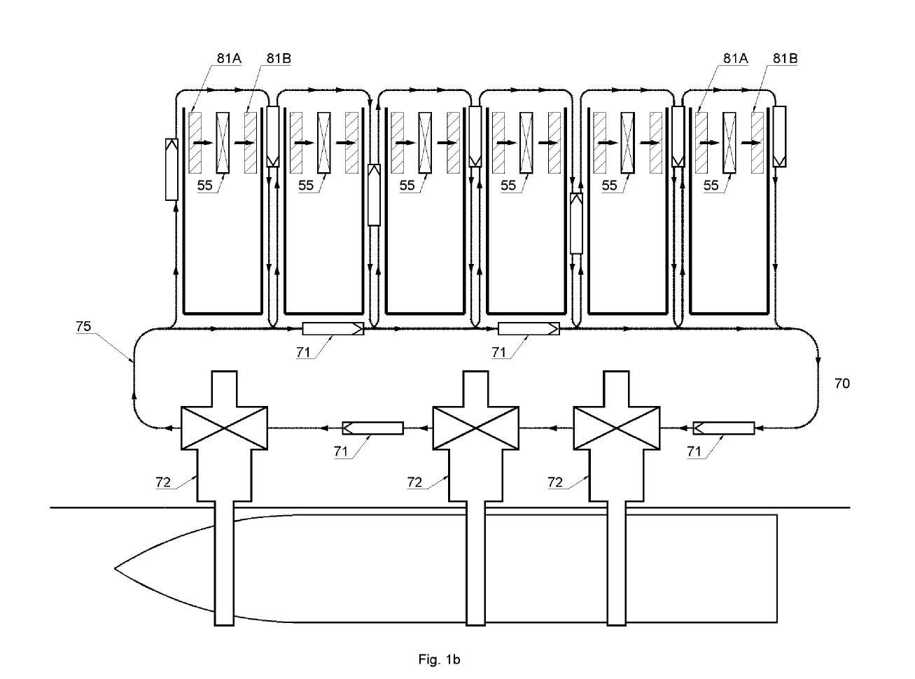

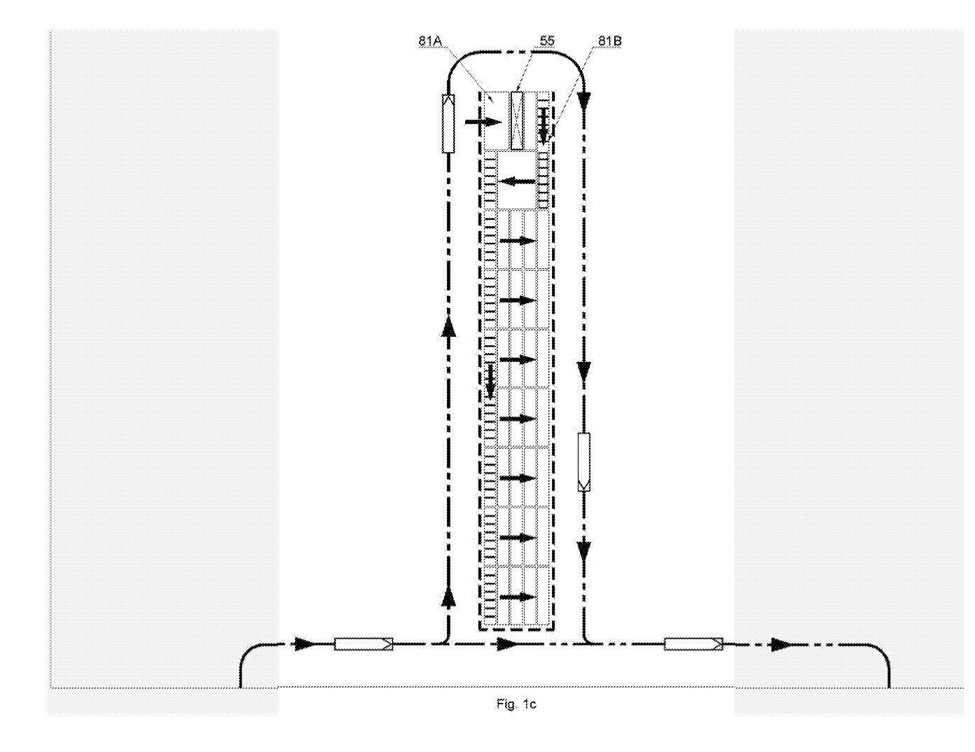

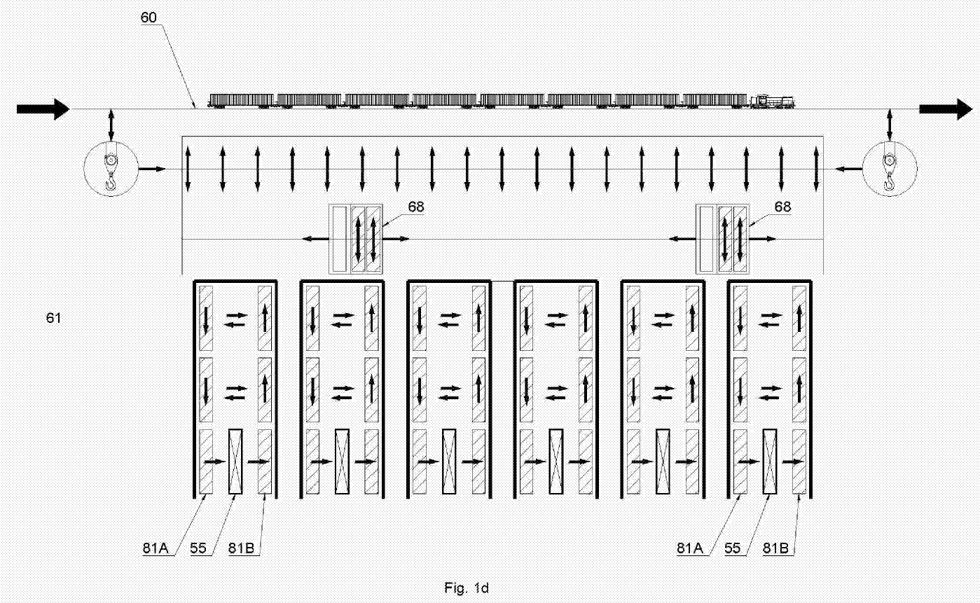

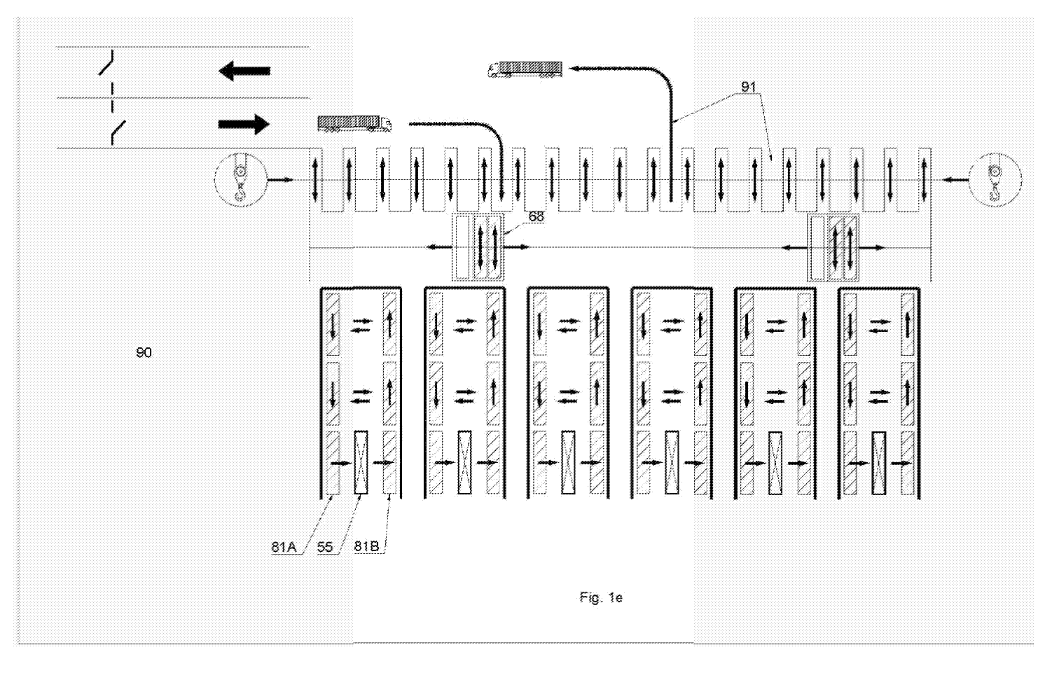

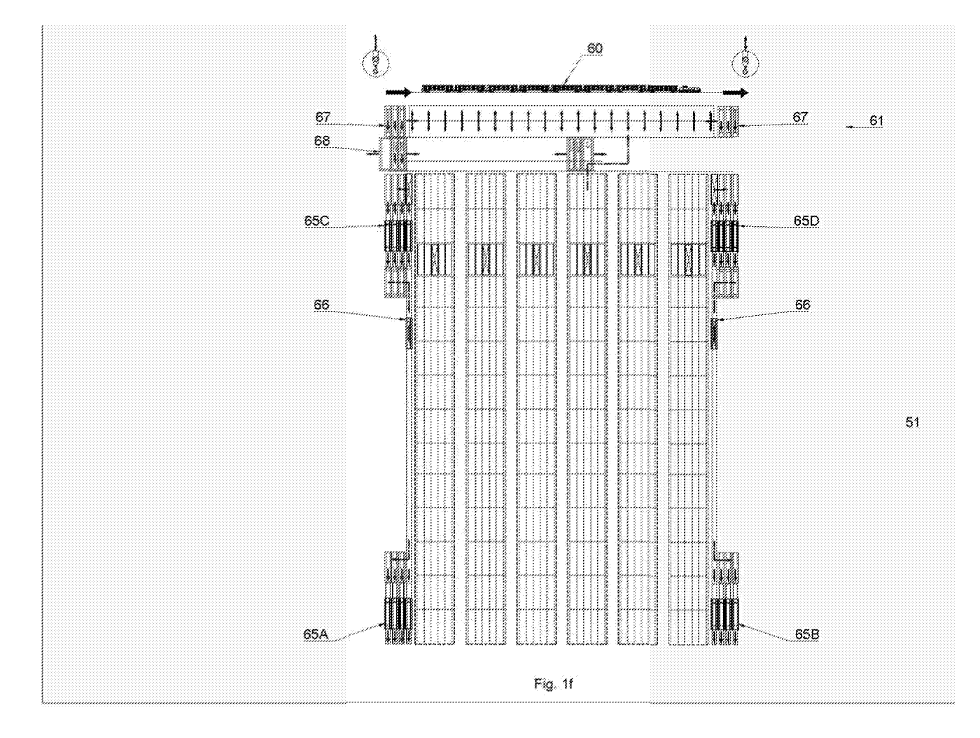

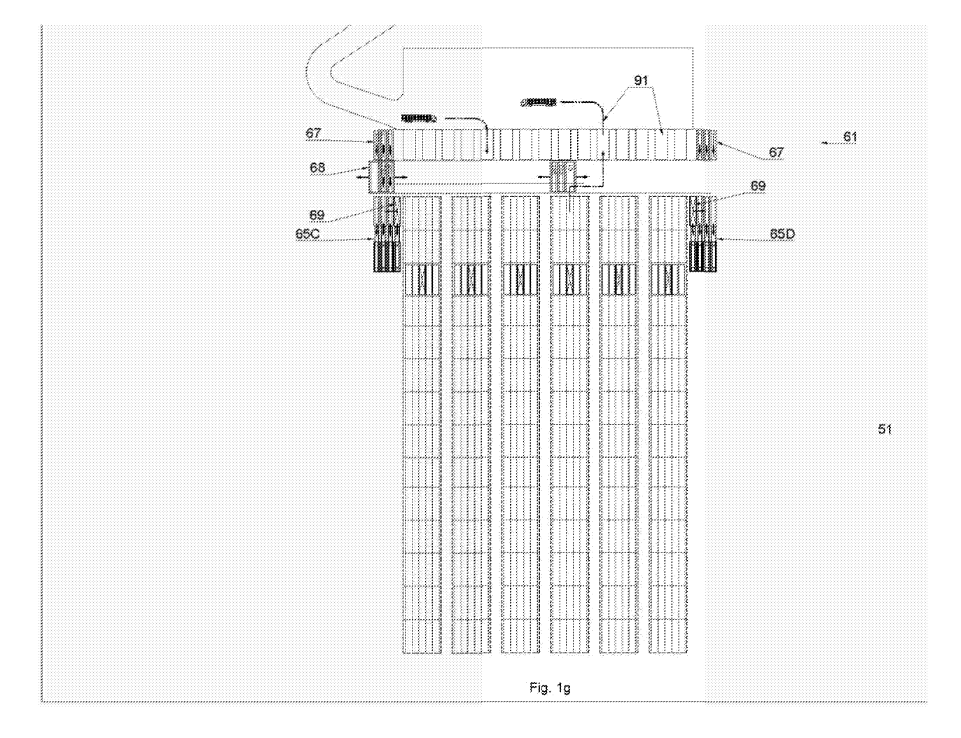

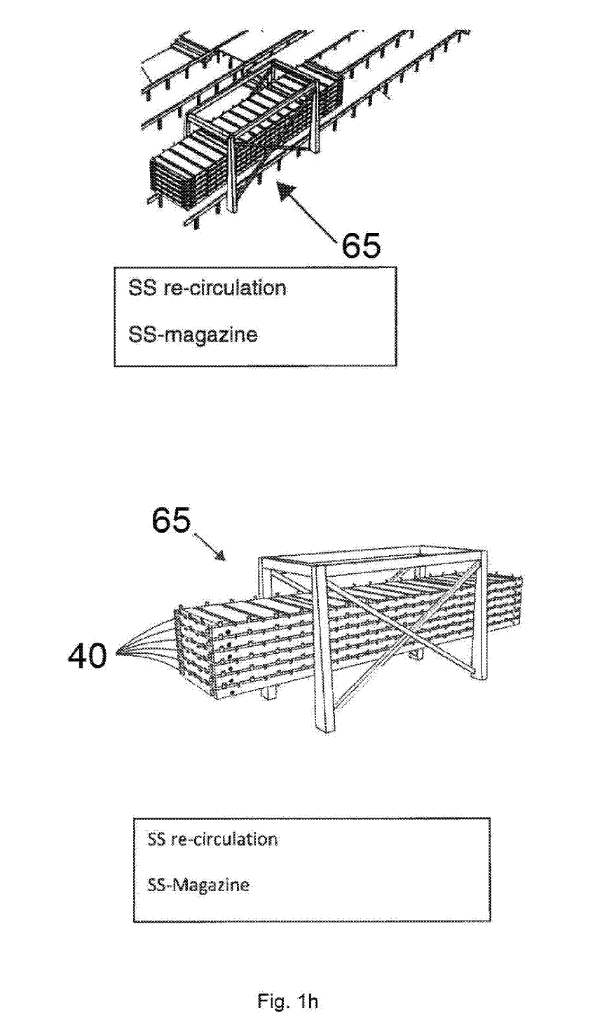

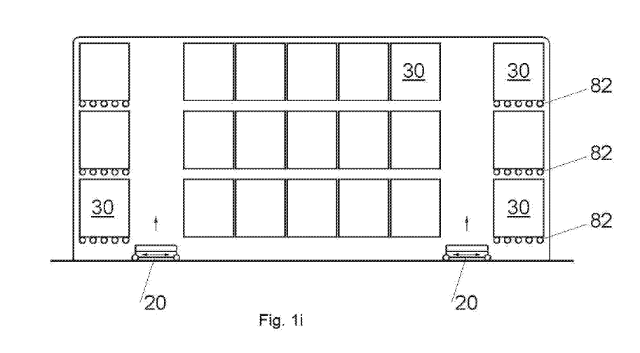

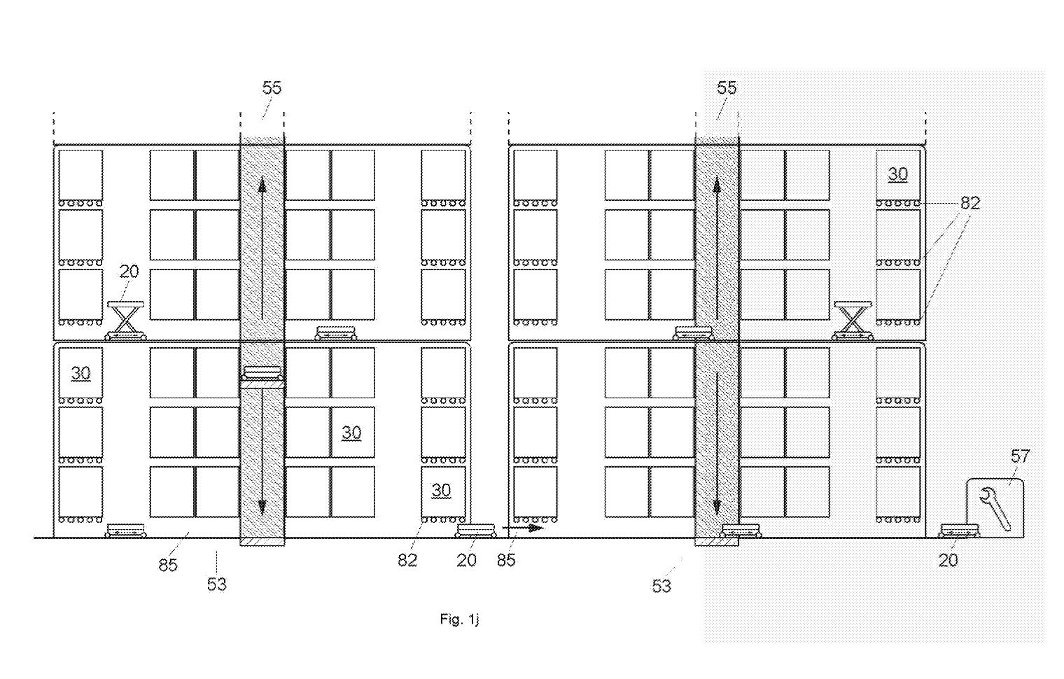

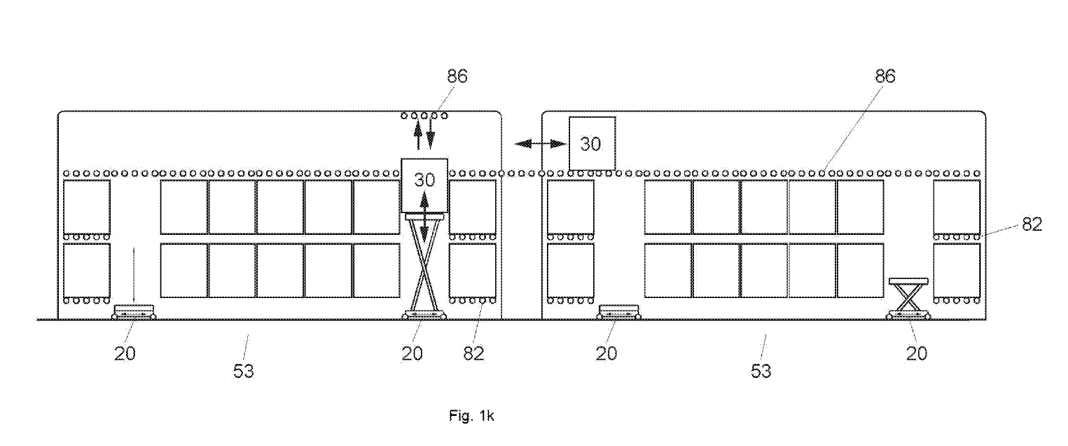

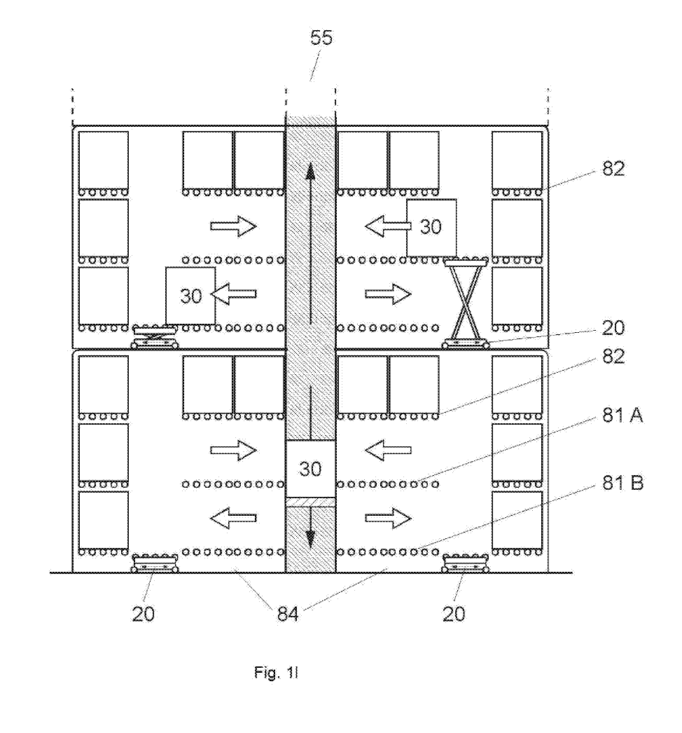

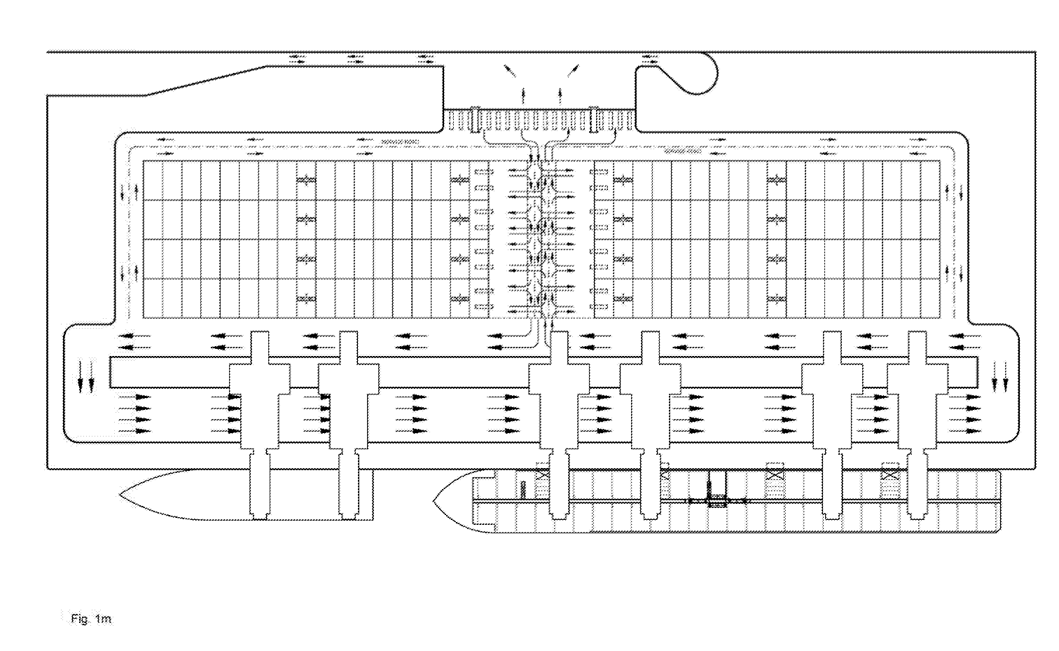

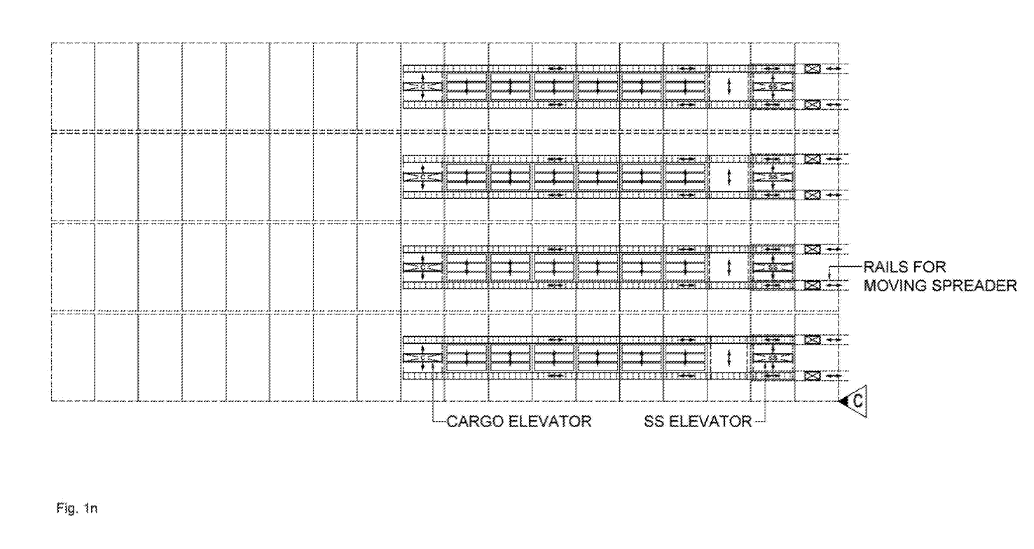

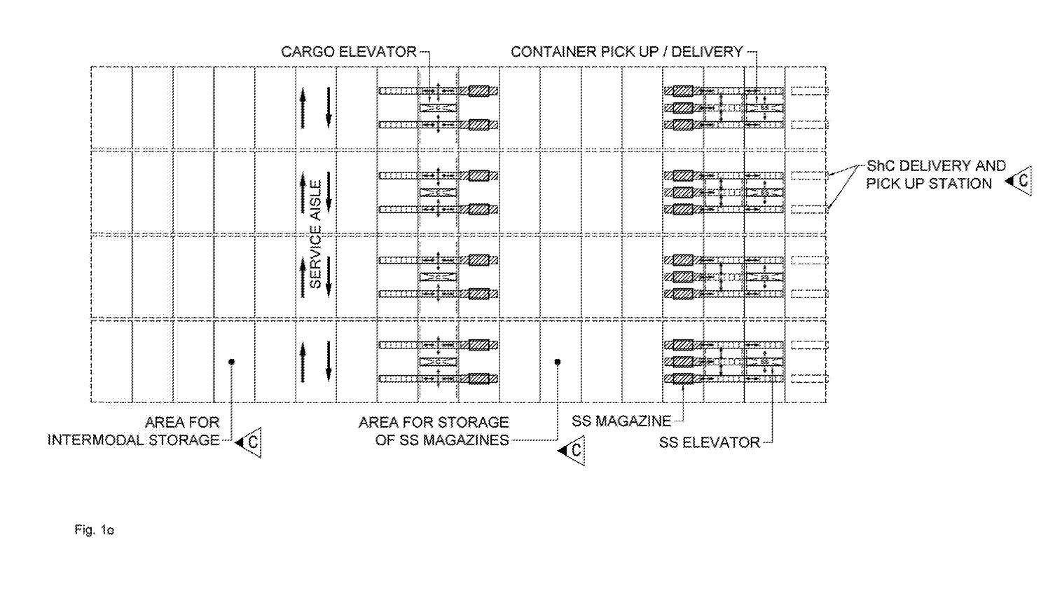

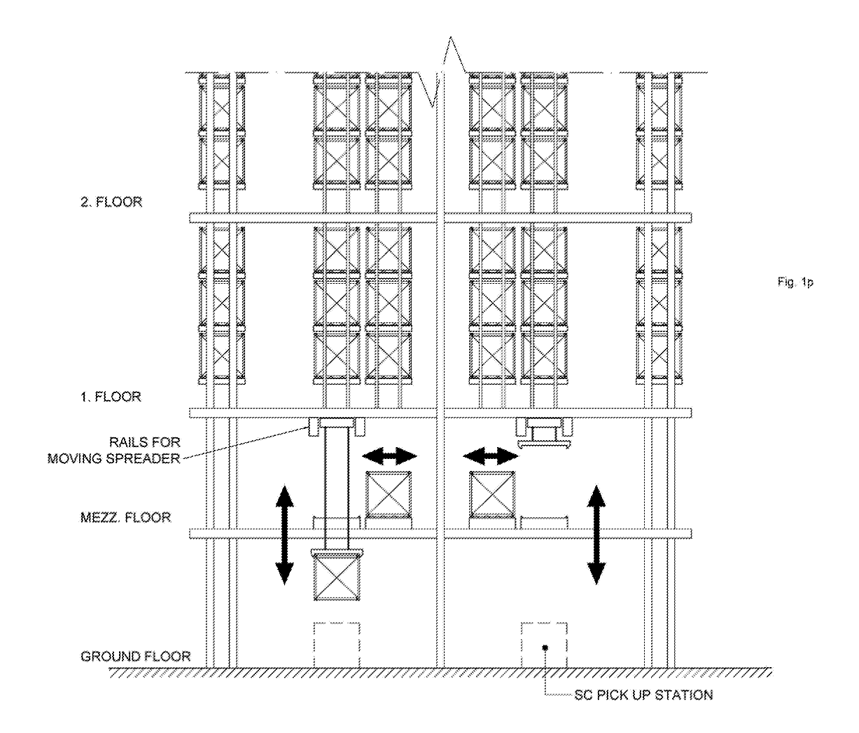

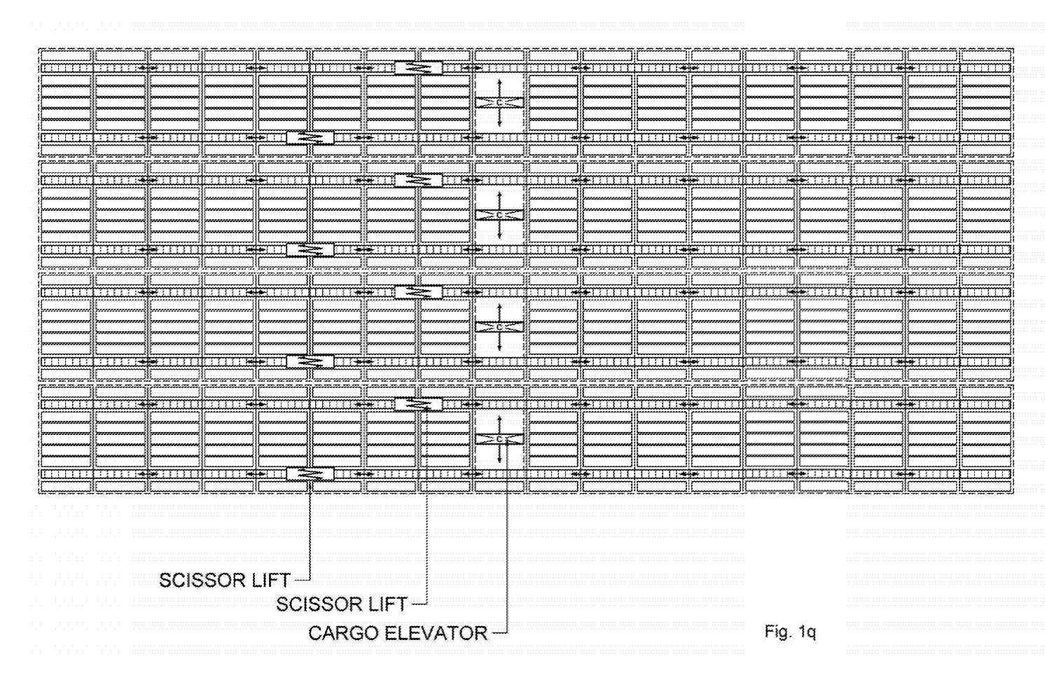

FIG. 1a shows a container terminal 50 with an automated modularized storage system 51. The modularized storage system comprising a number of modularized storage modules 52 stacked vertically to form a modularized vertical block 53, the blocks being arranged side by side to form the modularized storage system. Ocean ISO containers 30 are stored on standardized cargo load platforms 40 in the modularized storage system. The cargo load platforms are stored in suspended positions within the modularized storage system which provides a matrix of both vertical and horizontal storage positions. The modularized storage system enables a multiport vertical container terminal. Cargo trolleys 20 for transport of cargo load platforms are also provided within the modularized storage system. The containers in the context of the present invention are ocean ISO containers.

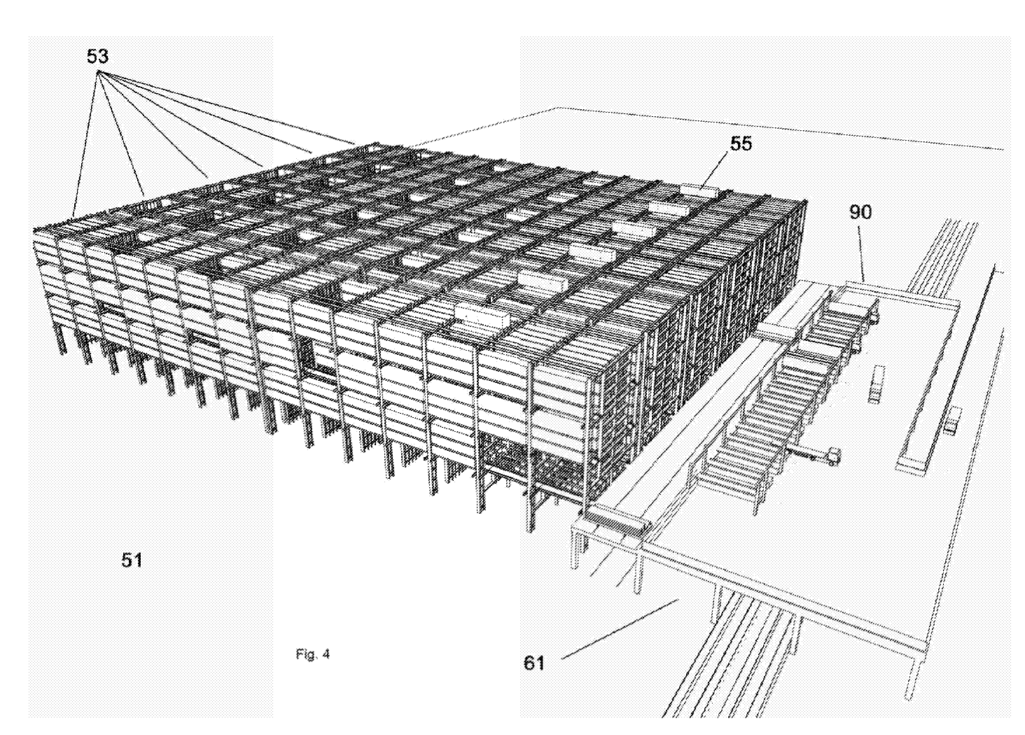

FIG. 4 shows a modularized storage system 51 in a container terminal for storage of containers. The modularized storage system replaces the stacks of containers placed directly on the quay side. The modularized storage system shown in FIG. 4 is constituted by six blocks arranged side by side. Each of the six modules are provided with an elevator 55 serving the entire module through infeed and outfeed buffer areas 83 for cargo load platforms and dedicated distribution aisles 15 on each base level. The block module is provided with a rail interface 61 and a truck interface 90. The modularized storage system may also be used in dry ports.

The containers 30 are stored in slots 3 in the modularized storage system. Containers for a specific vessel arrival may be stored in the same slot. The slot capacity may normally be from 1 to 15 or more containers permitting gradual build up of cargo while maintaining high cube utilization in the modularized storage system. This storage approach means that export cargo is marshaled at arrival to the terminal and is ready to be transferred to pier side on vessel arrival.

The container terminal may include communication between a pier side 70 and the modularized storage system 51, communication with truck docks 91 and communication with railway 60. The container terminal is based on a modularized construction allowing for gradual upgrading of existing terminals as well as gradual build up of new terminals. The modularized storage system may be prefabricated and shipped in standard ISO containers (e.g. 40 ft) for assembly on a prepared ground floor structure. The modular construction will be explained in detail later.

In the container terminal shown in FIG. 1a a container vessel 131 is loaded/unloaded at the quay by ship to shore (STS) cranes. The ocean ISO containers 30 are transported on cargo load platforms 40 between the pier side and the land side with vehicles as e.g. described in WO 2012/008846. FIG. 1a shows that a number of lanes 75 are provided for the transport vehicles/trolleys; a loading lane, a holding lane, circulation lanes, return lanes and entry/exit lanes. A pier container transfer system 100 may be arranged in connection with each ship to shore (STS) crane 72 to improve the STS crane productivity and reduce the number of transport trolleys 71 deployed between the pier and the modularized storage system. The pier container transfer system 100 is designed to receive/deliver loads from/to the modularized storage system 51, and receive and deliver loads 30 to the STS cranes in accordance with a vessel loading plan without incurring waiting time impact on the STS crane productivity.

A number of buffer areas 73 for storing ocean ISO containers on cargo load platforms 40 provided with foldable legs 43 are provided on the pier side. The buffer areas may be served by the vehicles 71 serving the pier side. The buffer areas are arranged side by side, and preferably arranged mainly parallel with the pier side, where the buffer areas serve a number of cranes when loading containers onboard a cargo vessel. These buffer areas reduce the distance for the transport of the ocean ISO containers to/from the cranes on the pier and also serve as a surge buffer to absorb peak over the pier volumes. The cranes may thus be served by a reduced number of vehicles needed for transporting the ocean ISO containers between the buffer positions and the cranes at the same time as the loading/unloading capacity of the cranes are increased due to efficient on demand supply and removal of containers to and from the loading/unloading area under the cranes. This is in contrast to the prior art solutions where vehicles are parked on the pier waiting for delivery of their containers to a crane or waiting in turn for pickup and transport of ocean ISO containers unloaded from the vessel. The buffer areas 73 are provided with a number of passages 74 for the vehicles 71 serving the pier side to ensure short and easy access to each crane. The lanes 75 for the vehicles serving the pier side are arranged encircling the buffer areas.

The land side of the terminal includes a maintenance and holding area 57 for the cargo trolleys. The maintenance and holding area is arranged adjacent to the modularized storage system. The maintenance and holding area communicates with the first level throughout the storage system and communicates vertically to any module 52 within the modularized storage system trough the elevators 55 providing cargo handling capacity in step with demand. A subsystem 64 for automatic handling, storage and circulation of cargo load platforms is provided integrated into the terminal design and shown in FIGS. 1f-1h. The subsystem 64 provides empty cargo load platforms 40 where needed and stores cargo load platforms when not needed. The cargo load platforms may be stored and retrieved automatically from a number of magazines 65A, 65B, 65C, 65D. The magazines are arranged adjacent to the automated modularized vertical storage system 51. A transfer system 66 for transfer of cargo load platforms between the magazines enables circulation and on demand supply of cargo load platforms. In Figure if the transfer system is arranged on the ground floor. The magazines may be provided both on the ground service floor (FIG. 1f) and on the first floor (FIG. 1g). The transfer system between the magazines may thus include lifts 69 between the magazines 65A, 65B, 65C, 65D arranged vertically above each other. Transfer between magazines in the same floor/level may be enabled by cargo trolleys. An example embodiment of a magazine for storing cargo load platforms may be found in WO 2012/008846 and shown in FIG. 1h. Roller stands 67 for spare cargo load platforms are also provided in the truck interface and the rail interface. The distribution trolleys 68 serving the trucks and railway may also be provided with magazines for cargo load platforms.

The magazines 65A, 65B, 65C, 65D, 67 and 68 thus provide buffer storage and on demand supply of cargo load platforms to cargo trolleys for the truck interface, the rail interface, the pier interface and for the modularized storage system.

The stack to pier communication is further illustrated in FIG. 1b. The different lanes 75 from FIG. 1a is only shown as a common lane. The transport vehicles/trolleys transport the containers on standardized cargo load platforms 40 from the pier side 70 to a ground service floor in the modularized storage system. The transport vehicles/trolleys unload the cargo load platforms with containers on infeed areas 81A in front of elevators 55 in the modularized storage system. A number of elevators 55 may be provided in the modularized storage system, and the transport vehicles/trolleys 71 may access each elevator. The elevators are each provided with an outfeed area 81B from which the transport vehicles/trolleys may pick up a cargo load platform 40 with container 30 and return to the pier side. The infeed 81A and outfeed 81B areas for the elevators are as shown in FIG. 1b provided on different sides of the elevator providing efficient circulation lanes for the transport vehicles.

The service floor connects the land side and pier side to the modularized storage system via elevators 55, which are preferably high speed elevators. The modularized storage system 51 is arranged on top of the service floor. The service floor may be constructed by extending the modularized vertical columns 54 and modularized vertical elevator 55 columns downwards forming a base level. The connection to land side is accomplished via conveyor arrangements. The conveyor arrangements enables communication directly with the modularized storage system and also permits containers 20, which are transported on cargo load platforms 40, to be moved directly to and from the vessels 131 to land side load out on a rail interface 61 or a truck interface 90. A part of a ground service floor is shown in FIG. 1c for a block 53 in the modularized storage system. Each block has a dedicated elevator 55 with a conveyor arrangement. The conveyor arrangement transfers cargo to and from the elevator to transport vehicles.

Preferably the conveyor arrangement (marked with arrows) on the service floor comprises a First In First out (FiFo) buffer storage (FIG. 1c, parallel arrows). The FiFo buffer storage receives containers from the modularized storage system via the elevator in accordance with the container vessel loading plan to minimize response time to pier side requirements. The modularized storage system connects to the pier side by means of a transport system provided by transport vehicles, as e.g. described in WO 2012/008846.

The FiFo buffer storage shown in FIG. 1c comprises a number of adjacent FiFo buffer areas served by conveyors transporting the containers on cargo load platforms from the elevator to a dedicated FiFo buffer area where the containers (on cargo load platforms) are stored waiting to be picked up by a transport vehicle. The FiFo buffer storage are arranged facing a return side of the circulation lane for the transport vehicles, preferably arranged after the outfeed 81B elevator conveyor.

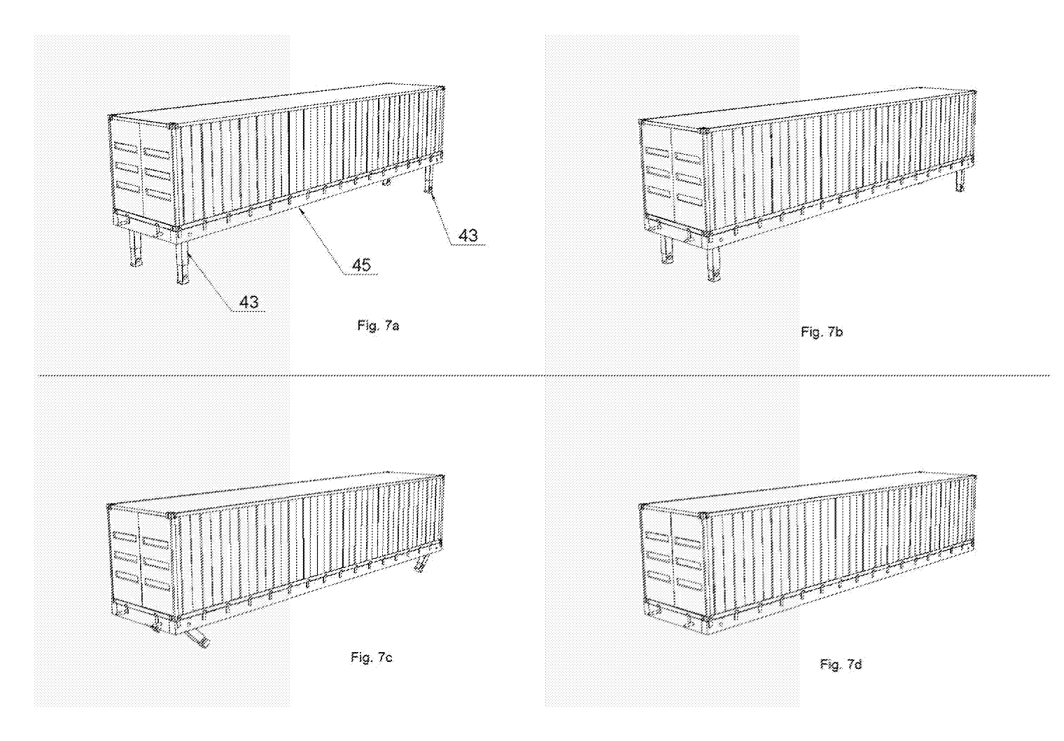

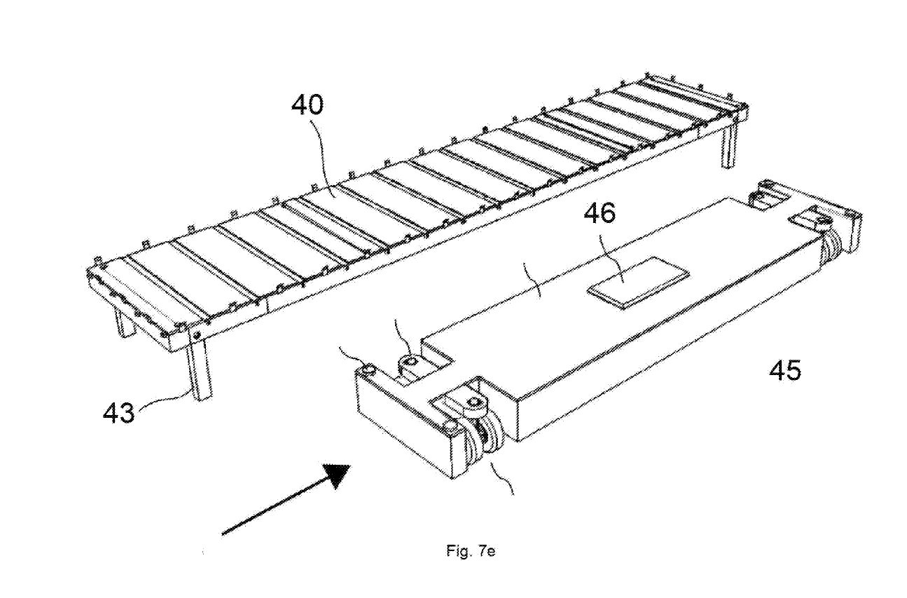

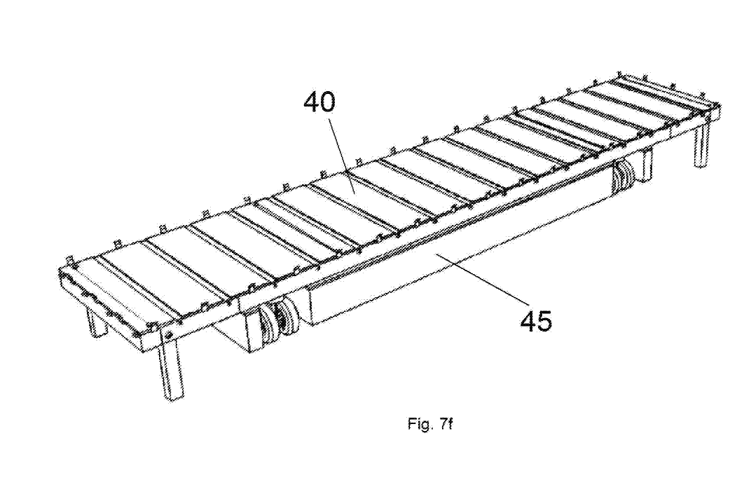

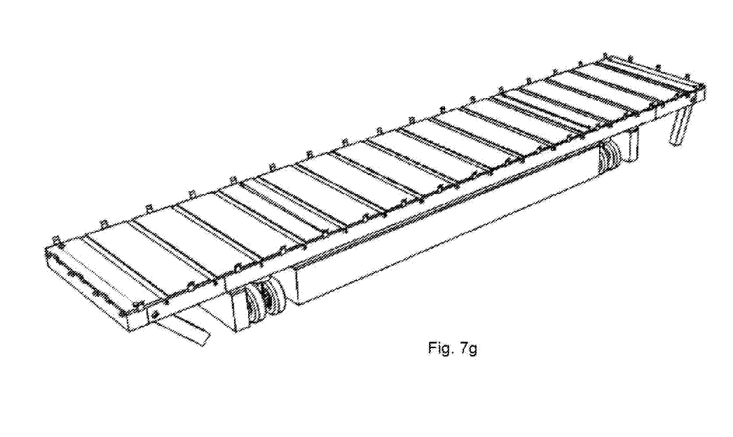

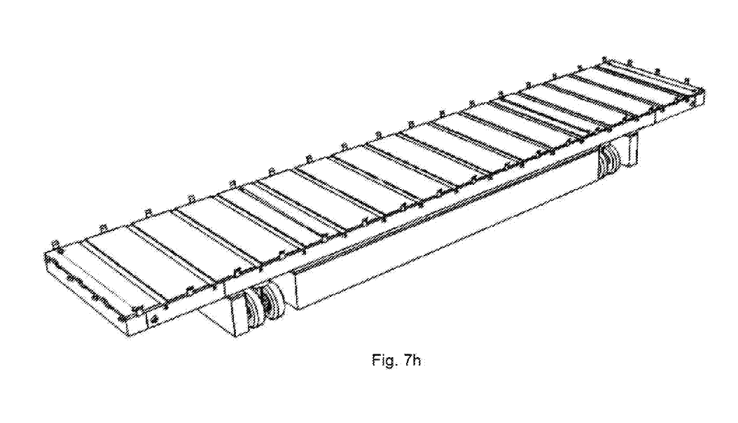

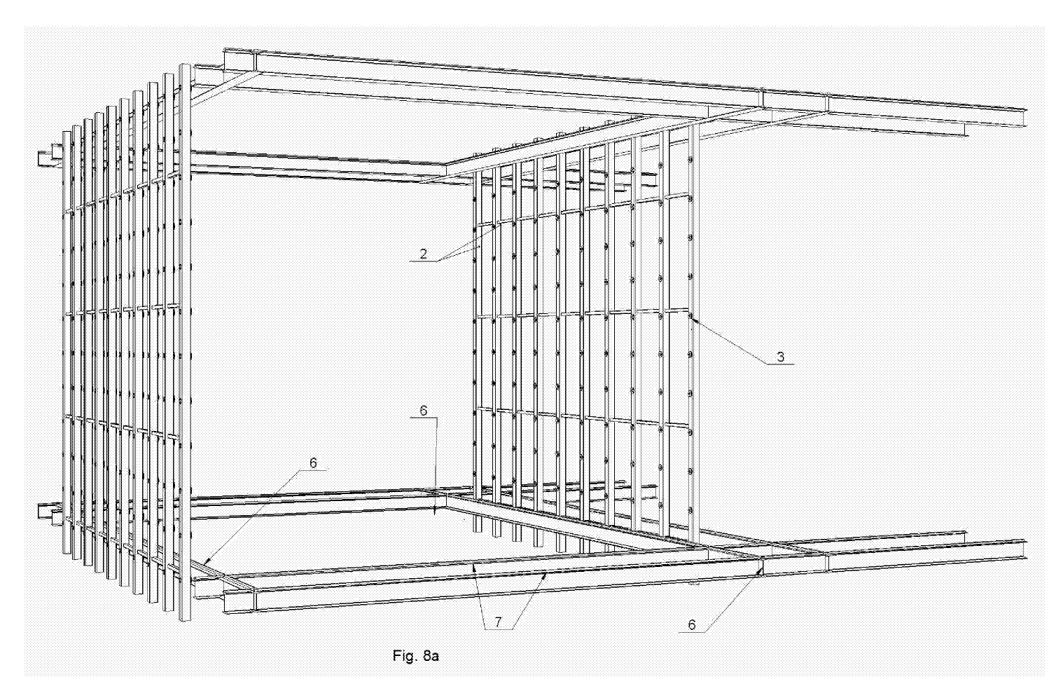

The transport vehicles pick up the cargo load platforms with containers from the FiFo buffer storage or from the elevator conveyors. The transport vehicles transport the cargo load platforms with containers to the designated STS crane 72 on the pier side, or to a the pier container transfer system 100 for a STS crane, or to buffer areas 73 on the pier side where the container is stored on the ground on the cargo load platforms 40 provided with legs 43. Storage on the ground may be accomplished by using a leg fold down feature of the cargo load platform. An embodiment of a cargo load platform provided with fold down legs is shown in FIGS. 7A-7D.

FIG. 1d illustrates a schematic flowchart for a rail interface 61 provided adjacent to the ground service floor of the modularized storage system 51. A conveyor system 81 (flow in the system illustrated with arrows) provides communication between the elevator buffer areas and cranes for loading/unloading the containers on/from the cargo train. As shown in FIG. 1d separate infeed 81A and outfeed 81B conveyor areas are provided for communication with the separate infeed and outfeed buffer areas provided in front of the elevators 55 on opposite sides. Cargo trollies 68 pick up the cargo load platforms with containers at the end of the buffer area 81 facing a trolley rail feed lane and transport the containers 30 on the cargo load platforms 40 on the rail feed lane to the assigned railway carriages. A crane lifts the container from the cargo load platform onto the railroad carriage. The cargo trollies 68 may be provided with roller conveyors and a magazine 65 that can store cargo load platforms 40. The empty cargo load platforms are transferred to the trolley magazine.

FIG. 1e illustrates a schematic flowchart for a truck interface 90 preferably provided on a mezzanine area adjacent to the first level of the modularized storage system 51. A conveyor system 81 (flow indicated with arrows) as detailed above for the rail interface is also provided for the truck interface. The conveyor system 81 communicates with cranes for loading/unloading containers to/from the trucks. The truck interface 90 and conveyor system 81 thus communicates with the elevators 55 in the modularized storage system on the first level. A number of truck docks 91 are provided for loading/unloading a number of trucks simultaneously. The empty cargo load platforms 40 are transferred to the trolley magazine 65. The trollies can serve import and export cargo at the same time, loading empty cargo load platforms at truck docks that are about to receive export cargo.

The truck deck 90 and the rail interface 61 is also illustrated in FIG. 4, which details an embodiment of a modularized storage system 51 for storing containers 30 on cargo load platforms 40. The truck interface 90 is accessed by the trucks on a mezzanine road access 63 from the truck gates. If the container terminal does not have a rail interface, the truck interface may be provided adjacent the ground service floor.

The modularized storage system 51 is based on modules 52 each with two transport aisles 15 which can be arranged side by side and in multiple vertical levels to accommodate the desired number of storage positions. The modules are interconnected by vertical elevators 55 serving the modules 52 stacked on top of each other. Scissor lift trolleys 20 operate in the module transport aisles 15 for storing/retrieving containers 30 on either side of the aisles into/out of storage slots. The containers are stored on standardized cargo load platforms 40 in the modularized storage system. The cargo load platforms are equipped with plungers 26 for storing the loads in a system of beams and columns. The cargo load platforms are also provided with legs 43 that can be folded down to facilitate ground storage.

In a further embodiment, the modularized storage structure 51 may be provided with roller conveyors 82 conveying cargo load platforms 40 (with containers 30) within the storage structure. The roller conveyors provide an additional transport route through the modularized storage system, increasing the flexibility of possible storage modes and the storage capacity of the storage structure.

FIG. 1i shows an embodiment where the cargo load platforms with ocean ISO containers 30 are locked to the vertical columns in positions enabling movement of the cargo trolleys 20 under the number of cargo load platforms with containers 30 enabling transfer of cargo trolleys 20 inside the modularized storage system 51. The containers 30 are thus stored in suspended positions on the cargo load platforms within the storage system. As shown in FIG. 1i, the cargo trolleys may run freely (indicated with arrows on the cargo trolley) on the underside of the cargo load platforms which are stored in the lowest vertical position in the storage level and thus provide access for the cargo trolleys to the two distribution aisles 15 shown in FIG. 1j. FIG. 1j also illustrates a mode with random access storage with roller conveyors 82 in the slots on the outer side of the transport aisles and block stow mode in the slot between the transport aisles.

Free transfer of cargo trolleys 20 between adjacent modularized blocks 53 may also be provided in the same manner by appropriately positioning the lower cargo load platforms with containers 30 in adjacent slots throughout the level as shown in FIG. 1j forming a transverse pathway 85. Suspending of the cargo load platforms with ocean ISO containers in the modules, together with lifts 55 in the modularized blocks 53, enables circulation of the cargo trolleys 20 throughout the entire modularized storage system 51 by enabling access to any transport aisle 15 in any block 53 in the modularized storage system. Access for the cargo trolleys 20 to a service shop 57 outside the modularized storage system is also easily provided as the cargo trolleys 20 may pass under the stored containers 30 and move outside of the modularized storage system.

FIG. 1k shows an embodiment where horizontal roller conveyors 86 are provided in slots on each level within the storage system. The horizontal roller conveyor 86 is running through all parallel modules 52. When elevator brake down occurs or for other reasons, cargo load platforms with containers 30 can be transferred horizontally between the blocks on the horizontal roller conveyor 86. The horizontal roller conveyor may be arranged in any vertical height within a level. In FIG. 1k the horizontal roller conveyors 86 are provided in the upper storage positions. A cargo trolley 20 provided with scissor lift may lift the cargo load platform with container 30 up to the horizontal roller conveyor 86. The horizontal roller conveyor may be provided with a mechanism for lifting a part 86 of the horizontal roller conveyor situated above the transport aisles 15 providing access to the horizontal roller conveyor system.

FIG. 1l illustrates use of roller conveyors 82 n different heights within a level for infeed 81A and outfeed 81B of containers 30 on cargo load platforms to and from the elevator 55 in a level. Infeed 81A and outfeed 81B roller conveyors serve as buffers between the elevator and cargo trolleys on each level. The cargo trolleys 20 serve the infeed 81A roller conveyors by lifting the cargo load platform with container 30 onto the infeed roller conveyor which is provided above the outfeed 81B roller conveyor. The elevator 55 serving the block 53 may stop in different vertical positions within a level communicating directly with the infeed 81A and outfeed 81B roller conveyors on each level. When the elevator platform corresponds with the base in a level, the cargo trolleys 20 can also drive onto the elevator platform and be transported to another floor level.

The scissor lift trolleys 20 can thus be moved freely into any module 52 within the storage system in the horizontal as well as in the vertical direction. This creates a highly flexible material handling capacity that can be deployed to support land side and pier side operational requirements throughout the storage system with short response times for unplanned events. The scissor lift trolleys can be transferred into central holding and maintenance areas when the terminal is not operating at peak capacity. The transfer of scissor lift trolleys 20 occurs at the base level in each module in the space between the lowest stored load and the base line for the module. The vertical transfer takes place by driving the scissorlift trolley under any loads 30 at the conveyor at elevator infeed 81A station, onto the elevator platform for transfer to any module base level, and discharged into the base level of the desired module.

The design of the storage system allows for different types of storage strategies and operational rules to be deployed ranging from Random access storage, First in first out storage (FIFO), different types of flexible block storage ranging from normally 2-15 ocean ISO containers. In slots 5 deep a variety of bulk storage modes may be established ranging from pure bulk storage for 15 loads or any combination of bulk storage using cargo access from both distribution aisles. The slots can be mechanized by introducing roller conveyors in the slots. A number of the slots are provided with roller conveyors (82) providing random access storage in at least some of the slots of the modularized storage module for the cargo load platforms (40) with container. In an embodiment, the random access storage may be provided by having roller conveyor sections installed in the outer rows of the modules which stores loads one load in depth. The scissor lift table is equipped with roller conveyors so that loads can be transferred onto the scissor lift trolley and transferred onto the roller conveyors in the slots. Roller conveyors may be arranged throughout an entire slot.

FIG. 1m shows an outline of an alternative embodiment of the container terminal. The modularized storage system 51 is in FIG. 1m divided in two parts and provided with a central passageway between the two parts. As shown in FIG. 1m the modularized storage system 51 is also arranged so that the side is parallel with the pier side. The interfaces of the modularized storage system with the pier side and land side are arranged facing the central passageway between the two parts. The modularized storage system in FIG. 1m is thus arranged in a turned configuration as compared to the embodiment in FIG. 1a where the interface is facing the pier side and facing the truck/rail side. The alternative embodiment in FIG. 1m has one interface side for each of the two parts. This arrangement in the alternative embodiment in FIG. 1m requires less pier space and provides less driving distance between the modularized storage system and the pier cranes. Shuttle carriers are used for transporting the containers between the modularized storage system and the pier side, and also between the modularized storage system and the land side.

Each of the two parts of the modularized storage system has a mezzanine floor for handling the flow of cargo to the pier side and land side. FIG. 1n shows an outline of the mezzanine floor. The mezzanine floor is provided with a conveyor system handling a programmed flow of containers stored on the cargo load platforms to and from the elevator. This function is different than the function in the container terminal in FIG. 1a where the mezzanine area was a sorting area for containers. The conveyor system is provided with two main conveyor lines. At the end of these conveyor lines the containers are lifted off the cargo load platforms by a crane and lowered to the ground for pick up by shuttle carriers. This crane may be an overhead crane equipped with a spreader beam. The crane may be moving on rails. The cargo load platforms, which now are empty, are transferred to a further elevator that lowers the cargo load platforms to the service floor where it is stored in magazines. This further elevator is reserved for transport of cargo load platforms. Magazines for storing empty cargo load platforms are arranged nearby all the elevators in the modularized storage system. The design of the mezzanine floor results in a solution where containers can be scheduled more directly in step with pier crane or land side requirements.

The conveyor system may further be provided with a number of buffer conveyors. The buffer conveyors may be arranged between the two main conveyor lines. The buffer conveyors may also be arranged in other configurations also on the outside of the conveyor lines. These buffer conveyors are used to accommodate changes in the sequencing of containers to and from the pier cranes, and flow into and out of the modularized storage system.

For import containers the process is reversed. The container is delivered on the ground by shuttle carriers. In this alternative embodiment of the container terminal the container is delivered without a cargo load platform. The spreader crane fetches the container delivered on the ground and lifts the container off the ground. A cargo load platform is provided by the elevator. The container, now on a cargo load platform, is moved towards the elevator on the conveyor lines and transported to its destination by the elevator and cargo trolleys arranged on the storage floors.

The design of the mezzanine floor provides a net effect of increased flexibility and fast response to last minute changes in loading plans.

FIG. 1o shows an outline of an alternative embodiment of a ground service floor of the modularized storage system of the alternative container terminal in FIG. 1m. A number of areas are provided for storage of empty cargo load platforms in magazines. Further, a number of storage areas may be provided for additional magazines for cargo load platforms. A number of areas are also provided for intermodal storage. Container pick up and delivery stations are provided on the ground adjacent the elevator and facing the passageway. A service aisle is also provided through the modularized storage system on the ground service floor ensuring transport possibilities through the modularized storage system. At the ground service floor a number of conveyors are provided from the elevator for pick up and delivery of containers. These conveyors provide a secondary position for input and output of containers to pier and land side in the event of disharmonies in material flow, equipment break down and major changes in loading plans. They also provide additional capacity required when simultaneous peak capacity is needed for both pier and land side operations at the same time. The overall effect of the design of the mezzanine floor and ground service floor is improved pier crane productivity and equipment utilization, faster vessel turnaround time, and increased revenue potential.

A truck interface may be provided on the mezzanine floor as in the container terminal in FIG. 1a. A railway interface may be provided on the ground service floor by the elevator with conveyors.

FIG. 1p shows an outline of a pick up and delivery station facing the passageway of the alternative container terminal. The overhead crane with spreader beam is seen placing and picking up the containers directly on or from the ground. FIG. 1q shows an outline of a top view of the storage floors of the modularized storage system in the alternative container terminal. This top view shows the arrangement of the elevator in the centre part of the storage structure.

The details explained above for the construction of the modularized storage system and the storage floors of the modular storage system also apply to this alternative container terminal.

Further details of the storage system outlined in the embodiments above will now be described.

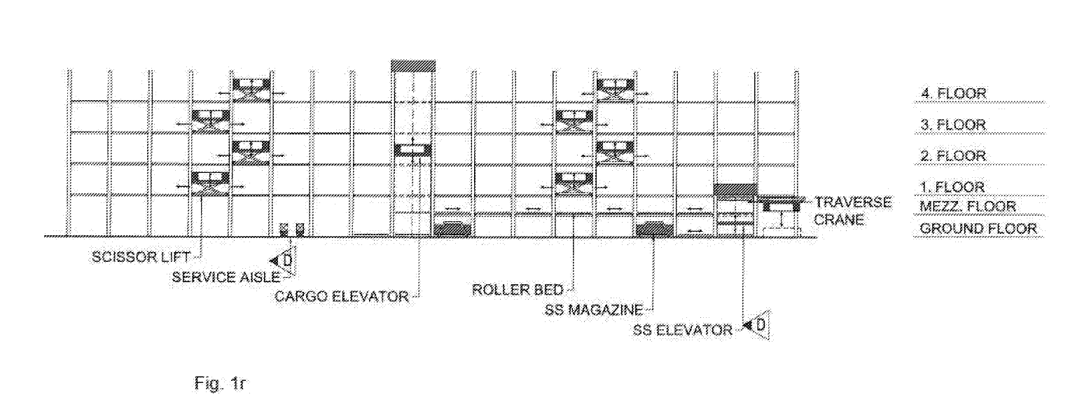

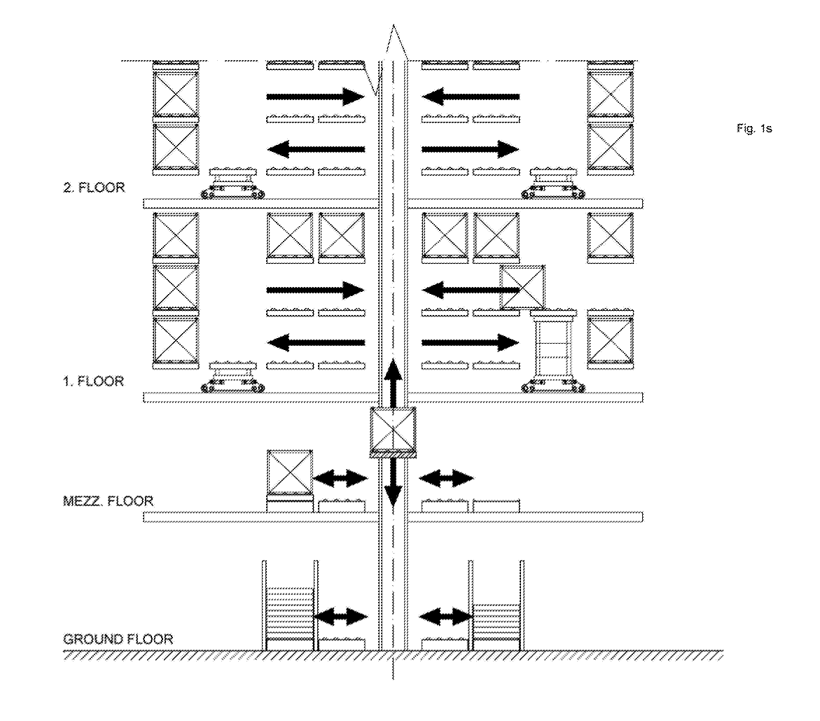

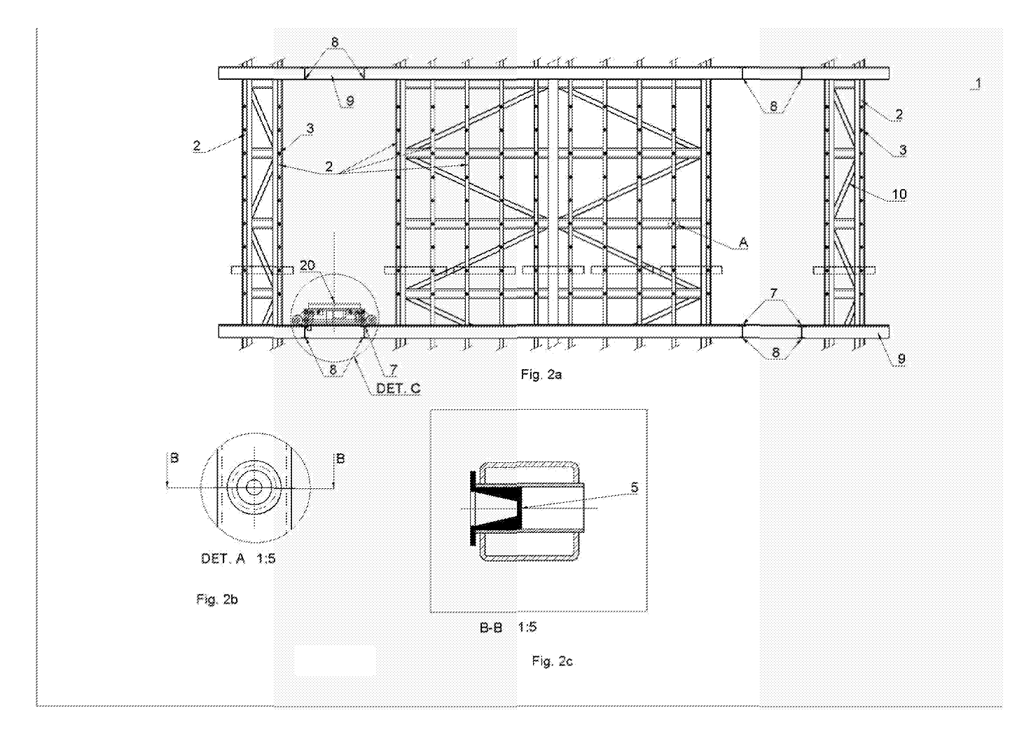

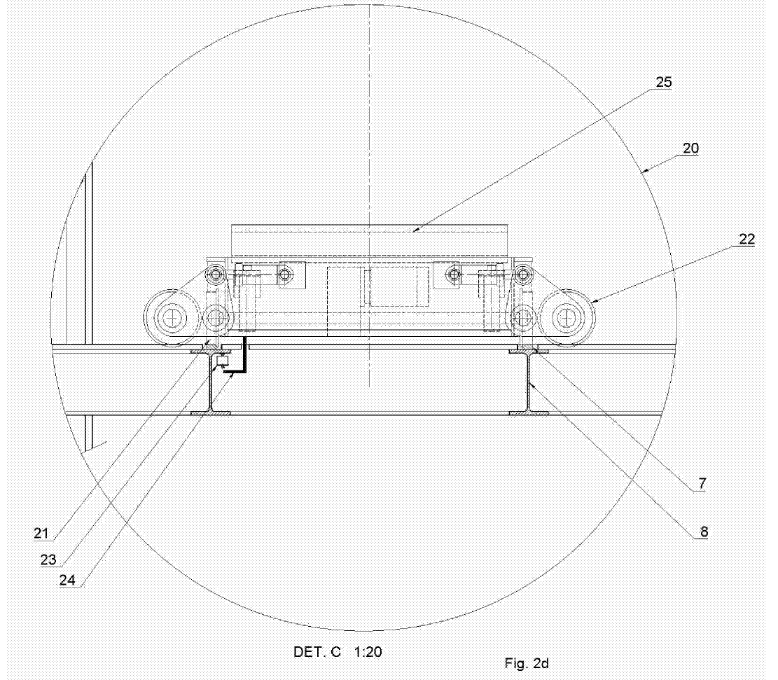

A detailed view of a modularized storage module 1 for a container terminal is shown in FIG. 2a. The modularized storage module comprising at least one modularized storage volume for storing/accommodating containers on cargo load platforms. The modularized storage volume comprises a plurality of modularized vertical columns 2 provided with a plurality of receiving means/receptacles 3 adapted for engaging the cargo load platforms. As can be seen from FIG. 2a the plurality of receiving means/receptacles 3 are arranged in a predefined vertical pattern along the modularized vertical columns 2. This predefined vertical pattern corresponds to a number of storage positions for a number of containers stored on a number of cargo load platforms. The modularized vertical columns defines a number of slots 4, where each slot provides a number of storage positions in a horizontal direction and a number of storage positions in a vertical direction. The modularized vertical columns 2 may be provided with bracings 10 stiffening the structure and maintaining the vertical and horizontal position of the columns. The bracings 10 may be in the form of bracing rods providing diagonal vertical and horizontal bracings. A number of modularized transverse 9 and modularized longitudinal 8 beams provide support of modularized transverse trolley rails 6 and modularized longitudinal trolley rails 12 and defines levels within the modularized storage structure. In FIG. 1a, two distribution aisles for transport of the cargo load platforms, with or without containers, on cargo trolleys 20 are provided. The distribution aisles are constituted by the modularized longitudinal rails 7 for the cargo trolleys 20 serving the modularized storage structure.

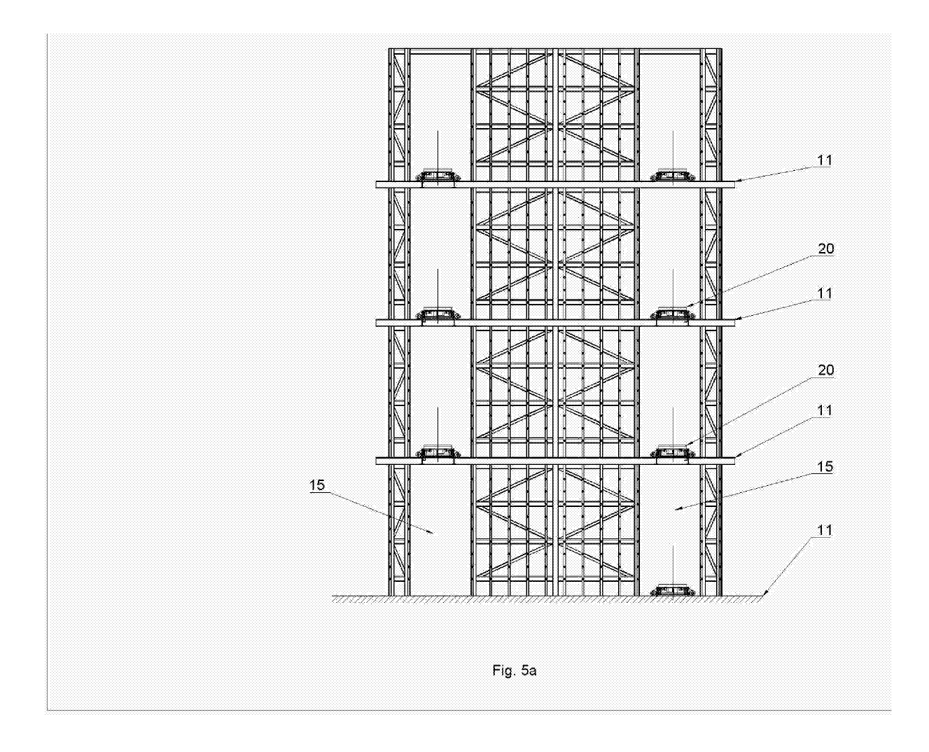

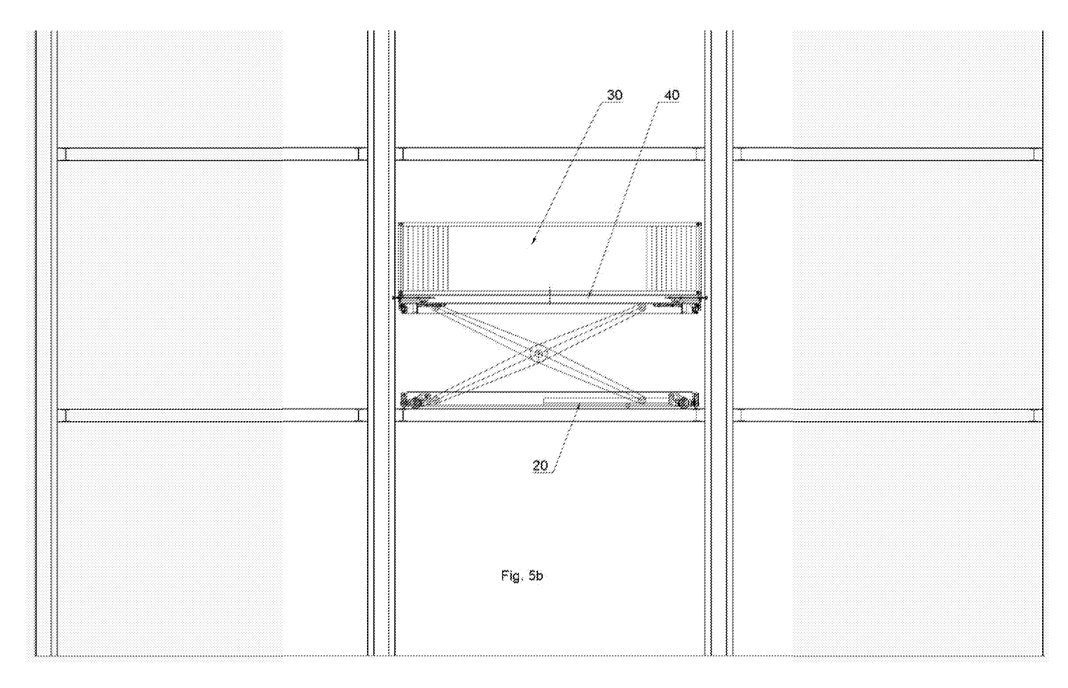

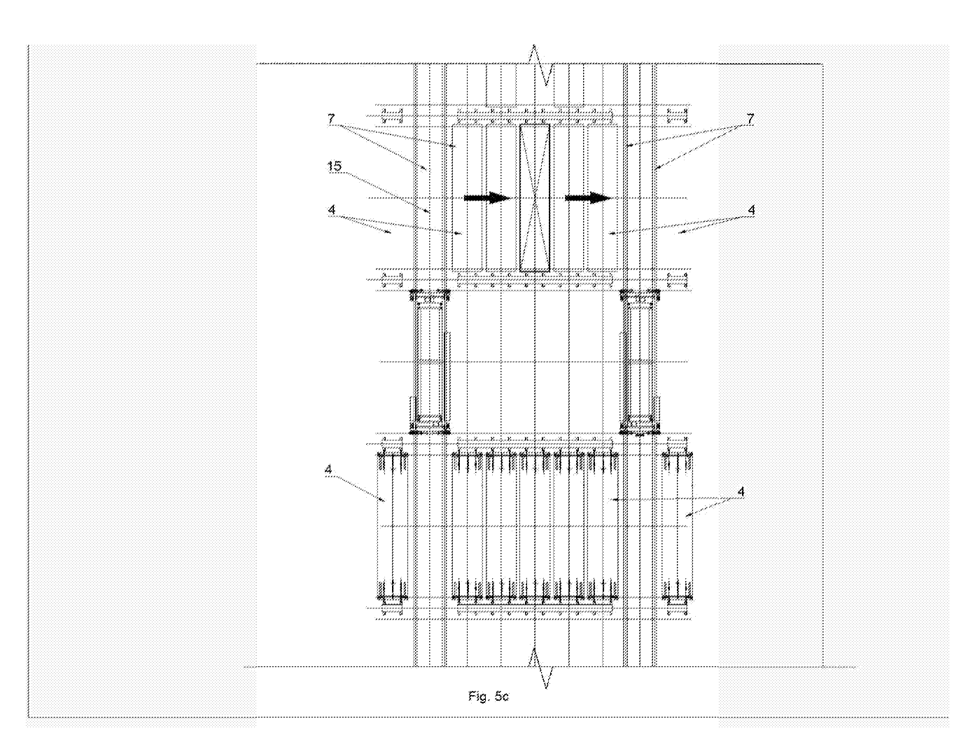

The modularized storage structure 1 is shown in FIG. 2a with four levels 11 (including ground level), each level provided with distribution aisles 15 for transport trolleys 20. The levels may be connected through a modularized elevator 13. The modularized elevator 13 is provided with at least one buffer area 14 on each level for infeed/outfeed of cargo load platforms with cargo to/from each level. FIG. 2b shows this modularized matrix structure from the side, where a transport trolley with scissor lift is about to place a cargo load platform with container in a dedicated storage position in a slot in the storage structure. As shown in FIG. 2c, which is one level of the storage structure from FIG. 2a seen from above, slots 4 for storage of cargo load platforms with containers are provided on each side of the distribution aisles 15. The slots 4 are arranged transverse of the distribution aisles 15. This is illustrated in e.g. FIG. 5a, where transverse rails 6 are provided for the three slots 4 (middle and on each side of the distribution aisle). The transverse rails 6 enable side transfer of the cargo trolley and cargo load platforms into and out of the slot 4.

The slots 4 can be of varying depth; i.e. varying number of storage positions in a horizontal direction. The number of possible load positions; i.e. storage positions in the vertical direction in a slot, depends on the number of receiving means in the vertical columns. However, as standardized ocean ISO containers come in more than one standard, the height of the container may have more than one height, and thus the number of storage positions in a slot may also depend on the standard container to be stored. In the embodiment in FIGS. 2a and 2c, the slots 4 on the outer side of the distribution aisles 15 have one storage position in the horizontal direction, whereas the slot 4 between the distribution aisles have 5 storage positions in the horizontal direction. Other configurations of distribution aisles, slots and number of horizontal storage positions are also possible. The distribution aisles may be symmetric or asymmetric, and a central distribution aisle is also possible. The outline of these configurations may also vary between levels. The actual design will depend on the required size and capacity of the storage structure.

In a preferred embodiment, each storage position in the horizontal direction in each slot 4 is defined by four modularized vertical columns 2. The length of the cargo load platforms 40 and the slot 4 lengths are adapted to each other. This enables support of the cargo load platform as close to the modularized vertical columns as possible. Preferably also a base size of each storage position in the horizontal direction in each slot is adapted to a base size of the cargo load platforms. The vertical cumulated load of all stored loads in the slots is transferred to the ground with a minimum of structural steel weight and with maximum cube utilization.

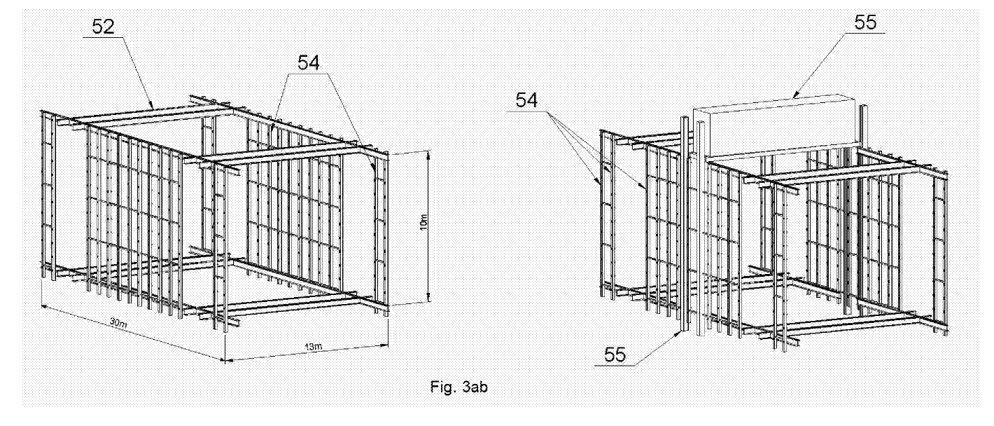

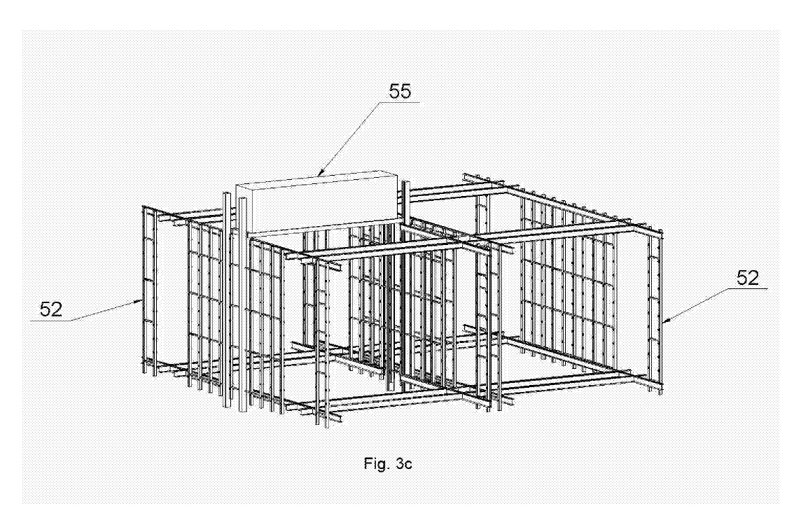

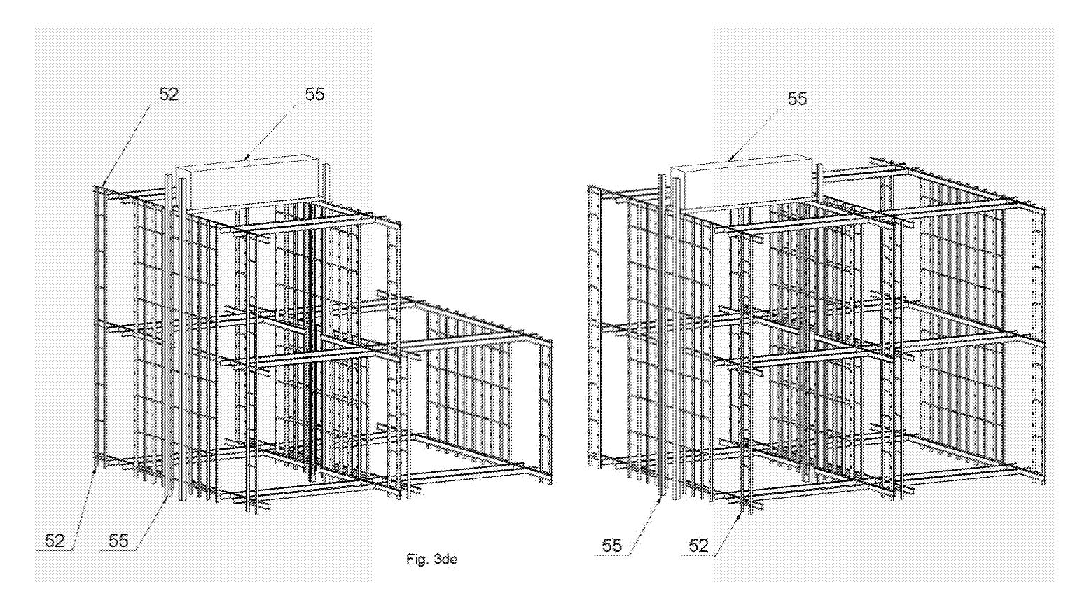

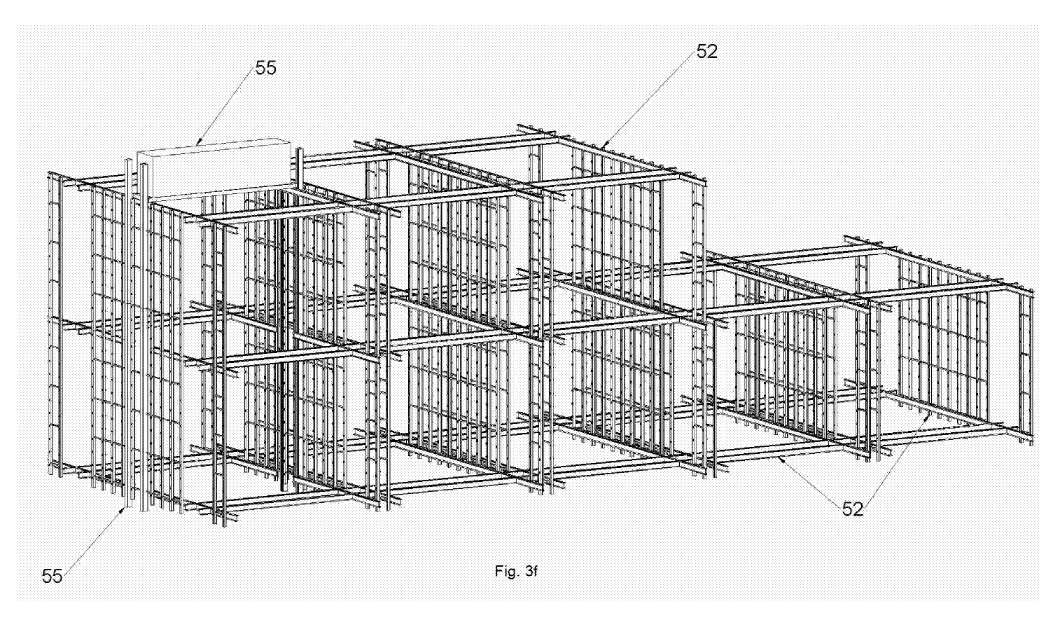

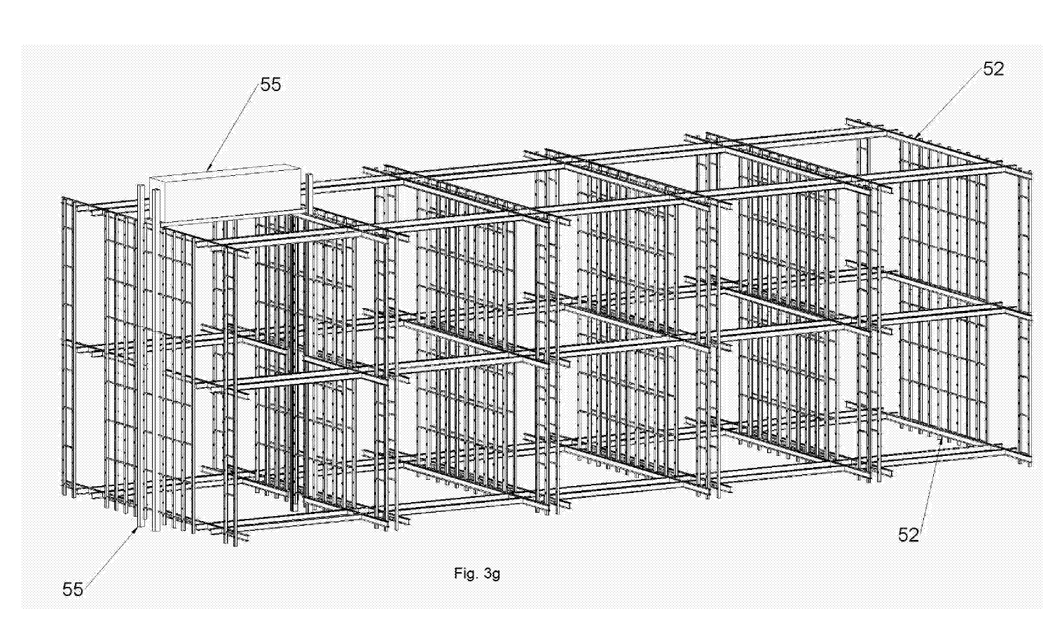

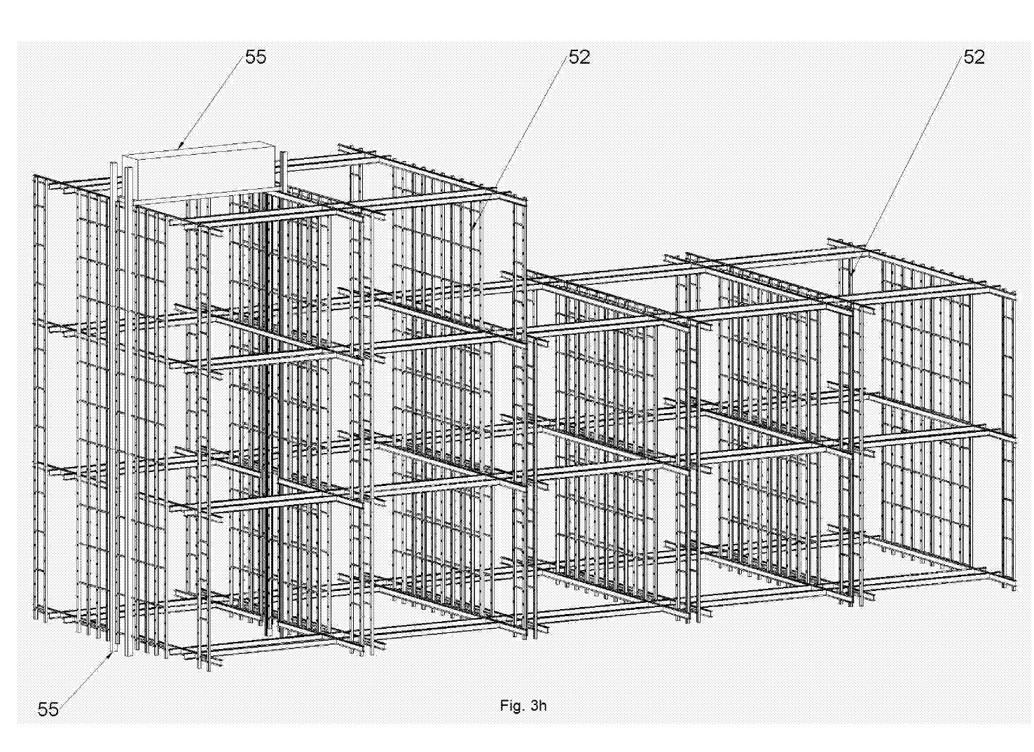

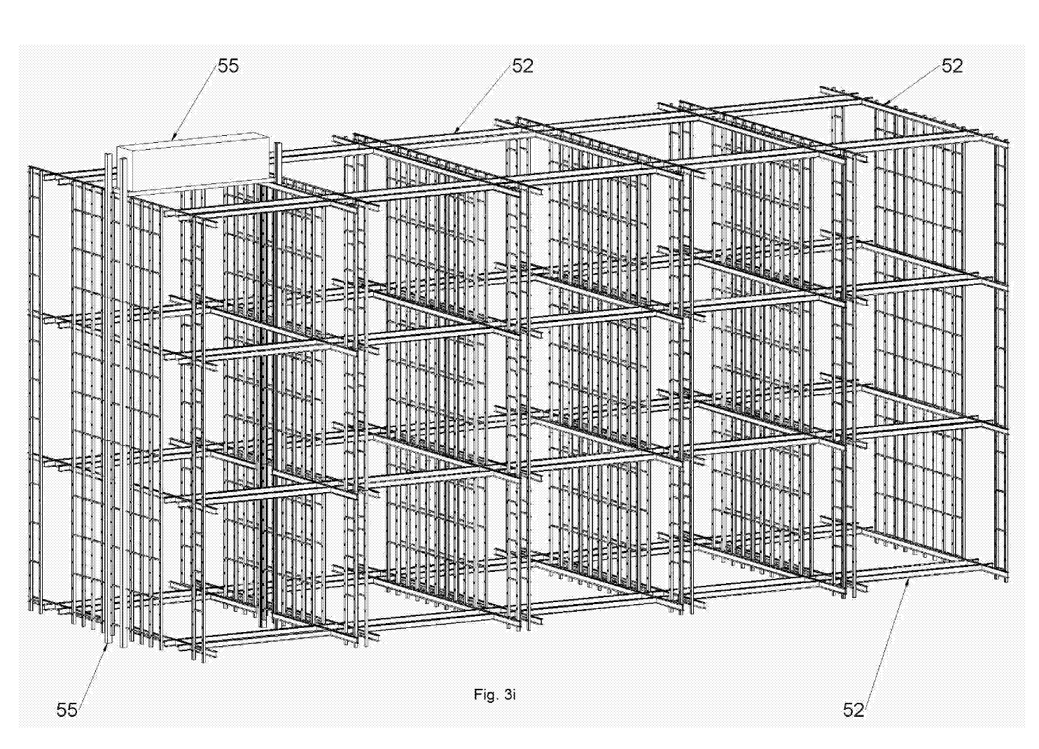

The storage structure 1 according to the invention provides a flexible modularized matrix structure. The modularized structure with its modularized columns, modularized beams, modularized bracings and modularized rails is preferably made of steel. The modularized columns may be square tube columns of high strength steel. The modularized vertical columns are easily vertically extendable in modular steps enabling construction of levels on top of each other. The modularized storage structure is also easily extendable in modular steps in the horizontal direction. The construction of a modularized structure starting with a basic module is shown in FIGS. 3a-3j.

FIG. 3a shows a basic storage module with a structure corresponding to the module shown in FIG. 2a. In FIG. 3b a modularized elevator is provided on top of the basic storage module from FIG. 3a. The modularized elevator may serve an entire level of horizontal storage modules. The modularized elevator comprises modularized vertical elevator columns extendable in modular steps. A height of the modularized vertical elevator columns is adapted to a number of modularized storage modules stacked on top of each other. The modularized elevator serves the two distribution aisles.

In FIG. 3c a basic storage module is added in a horizontal direction by extending the modularized longitudinal rails, adding modularized vertical columns and adding modularized transverse rails. The two horizontal basic storage modules are thus on the same level. FIGS. 3d and 3e shows an upgrade of the storage module from FIG. 3c with an additional level on top; i.e. forming a second level in the storage structure. The modularized elevator is extended vertically by one modular step. The modularized vertical columns are also extended by a modular step and modularized longitudinal rails and modularized transverse rails added. A basic storage module is added in a step in a horizontal direction in the second level by extending the modularized vertical columns from the basic storage module number two below, extending the modularized longitudinal rails in a modular horizontal step, and adding modularized transverse rails. The storage structure in FIGS. 3d and 3e after the upgrade is thus provided with two horizontal basic storage modules, two vertical basic storage modules and an elevator serving the two distribution aisles in the module.

In the same manner as explained above for FIGS. 3d and 3e, additional modules may be added in the vertical and horizontal direction by extending in modular steps the modularized vertical columns, the modularized longitudinal rails and the modularized transverse rails. The modularized elevator columns are extended in the vertical direction in modular steps for each additional level added in the modularized storage structure. FIG. 3f shows an outline of a storage structure with five horizontal basic storage modules and two vertical basic storage modules, and an elevator during an upgrade of the storage module to a storage structure with two levels with five horizontal modular steps. The storage structure from FIG. 3f after the upgrade is shown in FIG. 3g. The vertical and horizontal modules are added as explained above for FIGS. 3 and 3e. The elevator serves the entire modular structure through the two distribution lanes provided on each level. As for FIG. 3f, FIG. 3h shows a storage structure with five horizontal basic storage modules and three vertical basic storage modules, and an elevator, during an upgrade of the storage module to a storage structure with three vertical levels and five horizontal modular steps in each level. The modularized elevator is extended vertically by one additional modular step. In the same manner as explained above for FIGS. 3d and 3e, additional modules are be added in the vertical and horizontal direction by extending in modular steps the modularized vertical columns, the modularized longitudinal rails and the modularized transverse rails. The storage structure from FIG. 3h after the upgrade is shown in FIG. 3i.

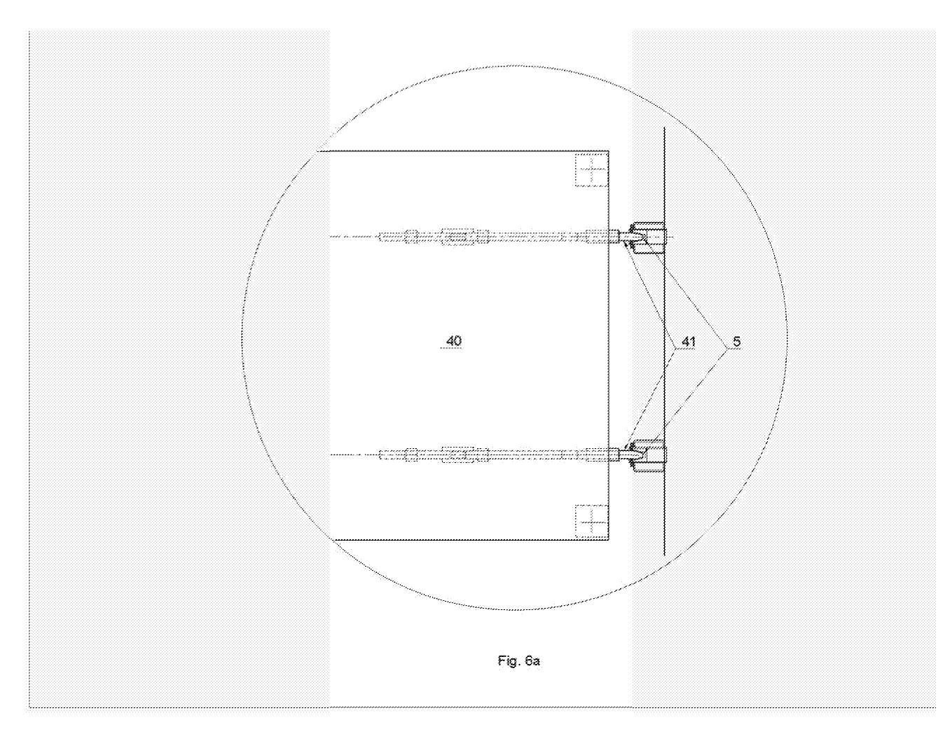

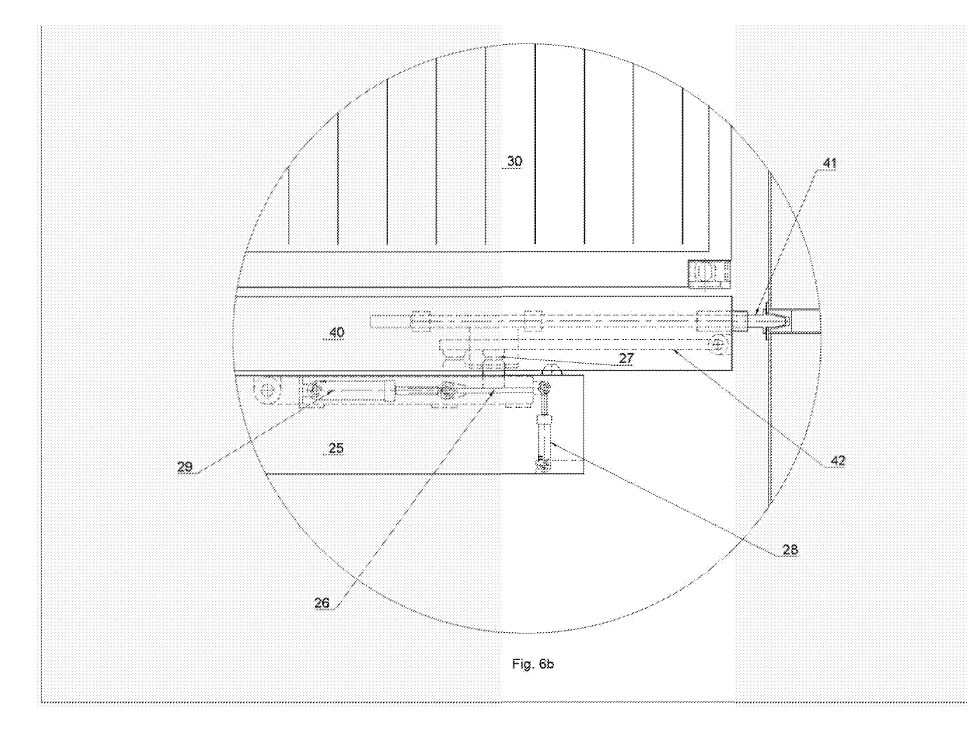

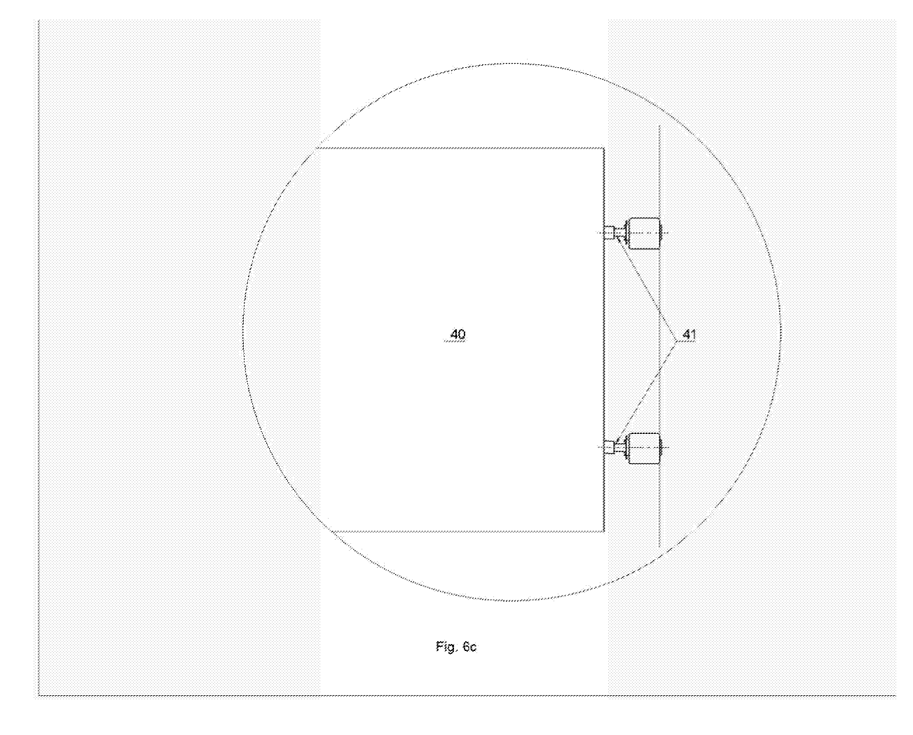

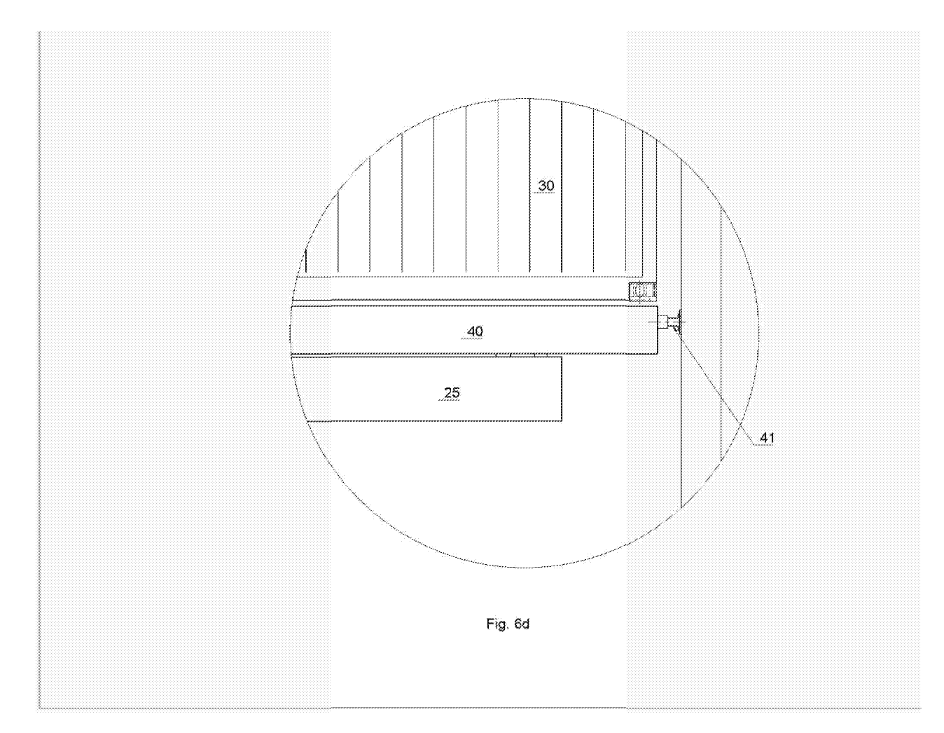

The modularized storage structure is served by a number of cargo trolleys 20 as shown in FIG. 2d. A cargo trolley 20 comprises a lifting platform 25 adapted for engaging a cargo load platform 40 and a chassis with a wheel arrangement enabling longitudinal and transversal movement of the cargo trolley. The wheel arrangement may be provided by two sets of wheel arrangements or may be provided by one set of wheel arrangements. In the case of two sets of wheel arrangements, the first set 21 of a wheel arrangement may be for running in the longitudinal direction along the transport aisles. A second set 22 of wheel arrangements are transversally arranged to the first wheel arrangements 21 for transversal transfer of the cargo trolley. The lifting platform 25 engages the cargo load platform from the underside. As illustrated in FIG. 5b a cargo trolley transports a cargo load platform with container along the distribution aisle 15 until the cargo trolley arrives at an allocated slot 4 for the container. When the cargo trolley is in correct position for side transfer into the allocated slot 4, the second set of wheels 22 on the cargo trolley are lowered down on the transversal rail track 6 engaging the steel rails. Lowering the second set of wheels, results in lifting of the entire cargo trolley, in order for the first set of wheels 21 to be lifted out of engagement with the longitudinal rails. The cargo trolley is then moved sideways into the slot by the second set of wheels. As shown in FIG. 5c the cargo trolley is moved sideways until the allocated horizontal position within the slot 4 is reached. The movement of the cargo trolley explained above may also be accomplished by a wheel arrangement with one wheel set. The cargo trolley is provided with a lifting mechanism for lifting and lowering the lifting platform 25. As shown in FIG. 5c, the lifting mechanism 32, in the form of a scissor lift mechanism, lifts the cargo load platform 40 with container 30 up to the allocated vertical position in the slot. An actuating mechanism on the lifting platform 25 of the cargo trolley actuates locking means on the cargo load platform engaging the cargo load platform with the receiving means in the vertical columns 2 in the slot. This is illustrated in more detail in FIGS. 6a-d, where a container on a cargo load platform is attached to the vertical columns through locking means in the form of plungers engaging corresponding conical receiving means in the columns. The lifting platform of the cargo trolley is equipped with a lower roller conveyor section at the short ends of the lifting platform (not shown in Figure) to enable transfer of a cargo load platform with an ocean ISO container to and from roller conveyors in the slots.

FIGS. 5b and 5c illustrates arrangement of a cargo load platform with container in a dedicated storage position in the modularized storage structure. The cargo trolley also operates retrieving cargo stored in dedicated positions within the structure. When retrieving cargo, the same procedure is applied for side transfer of the cargo trolley 20 into the slot 4 to the predetermined horizontal position beneath the cargo load platform 40 and lifting of the lifting platform 25 up into engagement with the cargo load platform 40. The actuating mechanism on the upper side of the lifting platform of the cargo trolley disengages the cargo load platform from the storage structure; the cargo load platform with container is lowered down on the lifting platform to a transport position, followed by side transfer of the cargo trolley into a transport aisle 15 for further transport away along the transport aisle.

As shown in FIG. 7a, the standardized cargo load platforms 40 are provided with locking means 41 for engaging the receiving means 3 in the vertical columns 2. The locking means 41 have preferably a conical end and may have the form of a plunger mechanism. Two locking means are arranged on each short side of the cargo load platform. The locking mechanism may also be in the form of a locking shaft, bar, rod or other longitudinal structure enabling secure engagement with the vertical columns. The receiving means 3 are preferably provided with conical guides 5 for the locking means on the cargo load platforms. The conical guides serve to guide the entry of the conical end of the locking means into the receiving means in the vertical columns. In addition, the scissor lift platform 25 of the cargo trolley 20 is provided with sensors 33 for fine adjustment of the scissor lift platform in the correct position. The locking means 41 is arranged in pairs on each side of the lifting platform 25, and the locking means are activated simultaneously. FIGS. 2b and 2c show an embodiment of the receiving means in the form of conical guides 5 in a front view, and seen from the side respectively. The receiving means/conical guides 5 may be in the form of steel housings provided with a solid lower part preferably made of high strength steel. The receiving means are preferably replaceable.

The standardized cargo load platforms 40 also comprises a securing mechanism 42 for securing the locking means 41 when the locking means is engaged to or disengaged from the modularized storage structure 1. The locking means are secured both in extended and retracted position. This provides secure locking in extended position of the cargo load platform with cargo in the storage structure. In the retracted position, secure transport of the cargo load platform along the rails in the modularized structure is enabled.

The details of an embodiment of the locking means 41 on the cargo load platform 40 and the external activating mechanism are shown in FIGS. 6a-6d. Each locking means is operated by an external activating mechanism. The external activating mechanism is provided in the upper side of the scissor lifting platform 25 on the cargo trolley 20 actuating the locking means on the cargo load platform form the underside of the cargo load platform.

As shown in FIGS. 7a-7d, the cargo load platform may be provided with a number of legs enabling the cargo load platform, with or without container, to be stored in a standing position without being attached to a storage structure. The platform structure is in FIGS. 7a-7d provided with four of legs. A mechanism is provided in the cargo load platform for folding the legs into and out of the platform structure. The mechanism may be activated through a mechanical connector on the underside of the cargo load platform for connecting to an external drive means. The external drive means may activated by a cargo trolley. The folding of the legs makes the load platform conveyable on mechanized conveyors.

Further, the cargo trolley may include a drive mechanism with a connector on the upper side of the chassis for mating with a corresponding connector on the underside of the cargo load platform, for folding or un-folding the legs. FIG. 7e-h illustrates as a sequence of steps how a cargo trolley is moved sideways below the cargo load platform, the trolley lifting the load platform, connecting to the load platform and folding the legs on the load platform, and turning the wheels into the appropriate direction for further transport.

The cargo trolley may be adapted for hydraulically accumulation of power, diesel electric powered, through induction or combinations of the power forms. The cargo trolley may receive its energy supply from modularized power rails 23 mounted in the distribution aisles 15. When operating in the slots, power may be provided through a combination of battery capacity and hydraulic accumulators.

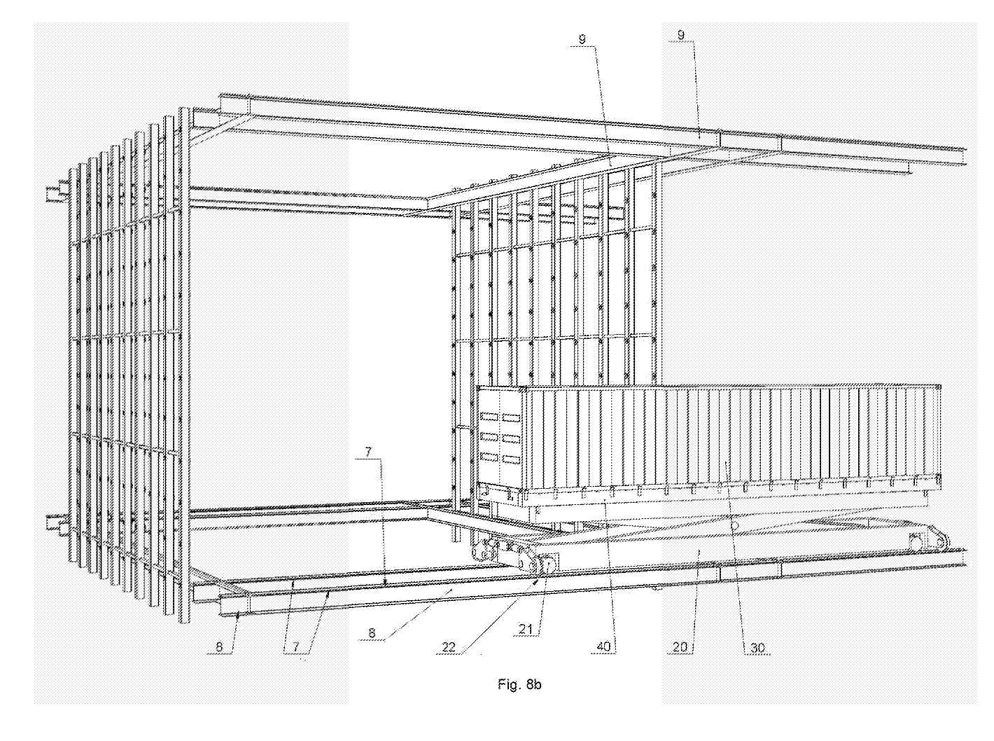

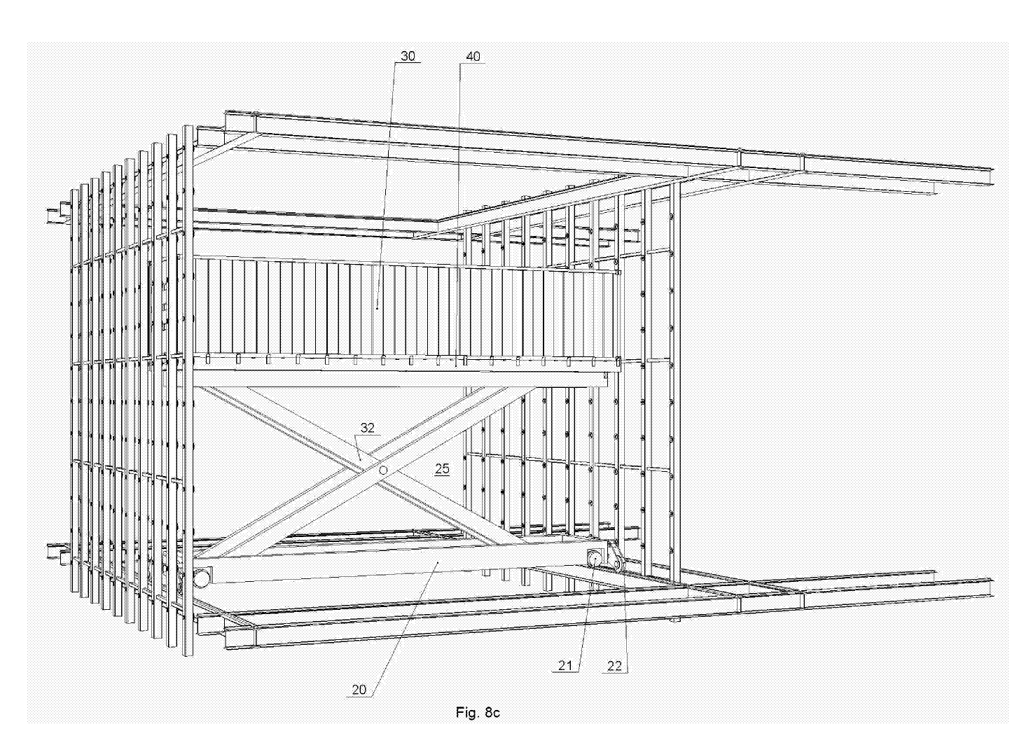

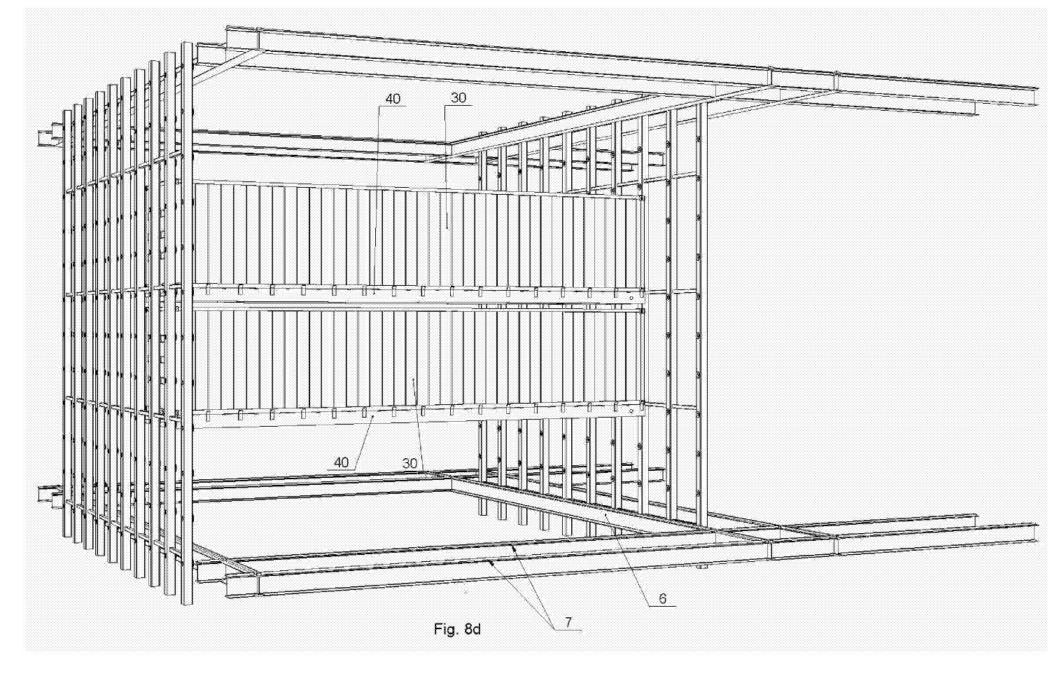

FIG. 8a is a schematic outline of a slot in a part of a modularized storage structure with modularized columns and modularized beams providing storage positions for containers stored on cargo load platforms. FIG. 8b shows the slot from FIG. 8a upon arrival of a container on a cargo load platform transported by a cargo trolley. FIG. 8c shows arranging of the cargo load platform with container in a predefined storage position in the slot by a scissor lift system of the cargo trolley. FIG. 8d shows the slot with containers on cargo load platforms fixed to the storage structure.

### Terminal Operating System

A terminal Operating system (TOS) is the main terminal management tool for the operation of the container terminal. The TOS system coordinates all operational activities in the terminal and is interphased to communicate with external users of the terminal and provide and receive information to freight forwarders, trucking and rail service providers and the vessel operators.

The TOS provides information to terminal subsystems such as inventory control equipment, operation, accounting, planning etc.

The terminal with the modularized storage structure according to the invention results in at least a 50% reduction in area use compared to existing state of the art technology terminals with comparable pier length and throughput.

The level of automation for all terminal handling in the present invention may be 100% except for application/removal of any twist locks at the side pier and for final handoff of containers to trucks/rail.

This invention provides economical vertical storage of containers and a level of automation that dramatically decreases the response time of the modularized storage system to serve land side and pier side operations and eliminates the need for multiple handling of containers. The improved pier side productivity results in faster turnaround of vessels and enables more vessels to be served for a given length of pier thereby increasing terminal revenue and profitability. The invention enables efficient use of the maximum capacity of the STS cranes on the pier side. Each STS crane can handle up to 50-60 loads an hour which can be supported by the container terminal of the present invention.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1. Container terminal comprising:
an automated modularized vertical storage system for storing ocean ISO containers on standardized cargo load platforms, the automated modularized vertical storage system comprising a number of modularized storage modules stacked vertically on top of each other forming a modularized block, wherein a number of modularized blocks are arranged side by side forming the automated modularized vertical storage system, wherein the ocean ISO containers are stored on standardized cargo load platforms in slots in the modularized storage system, wherein the slots are arranged transverse of a distribution lane, each slot providing at least one storage position in a horizontal direction and at least one storage position in a vertical direction, and wherein a number of the slots are provided with roller conveyors providing random access storage in at least some of the slots of the modularized storage system for the cargo load platforms; and
a number of cargo trolleys for transport of cargo load platforms within the automated modularized vertical storage system, wherein each cargo trolley comprising a wheel arrangement enabling longitudinal and transversal movement of the cargo trolley, and a lifting platform for transporting and lifting a cargo load platform, wherein the lifting platform is provided with roller conveyors for transfer of cargo load platforms and containers to and from roller conveyors arranged in the slots in the modularized storage system.

2. Container terminal according to claim 1, wherein each modularized storage module comprising a plurality of modularized vertical columns having a plurality of receiving means/receptacles adapted for engaging the cargo load platforms, wherein the cargo load platforms comprising locking means for engaging the receiving means/receptacles.

3. Container terminal according to claim 1, wherein at least a number of the cargo load platforms with ocean ISO containers are locked to the vertical columns in positions enabling movement of the cargo trolleys under the number of cargo load platforms enabling transfer of cargo trolleys inside the modularized storage system.

4. Container terminal according to claim 3, wherein the automated modularized vertical storage system further comprising a maintenance and holding area for the cargo trolleys arranged adjacent to the automated modularized vertical storage system communicating with the automated modularized vertical storage system, enabling maintenance, storage, on demand supply of the cargo trolleys throughout the modularized storage system.

5. Container terminal according to claim 1, further comprising a subsystem for handling, storage and circulation of cargo load platforms, said subsystem comprising a number of magazines for cargo load platforms arranged adjacent to the automated modularized vertical storage system, and a transfer system for transfer of cargo load platforms between the magazines.

6. Container terminal according to claim 1, further comprising at least one of:
a number of truck docks communicating with a truck interface of the modularized storage system; and
a number of railway tracks communicating with a railway interface of the modularized storage system.

7. Container terminal according to claim 1, further comprising a pier side, and a number of vehicles connecting the automatic modularized vertical storage system to the pier side.

8. Container terminal according to claim 1, further comprising a number of pier side ship to shore (STS) cranes for loading/unloading a cargo vessel.

9. Container terminal according to claim 1, wherein the pier side of the terminal comprising a number of buffer areas arranged side by side for storing containers on cargo load platforms provided with foldable legs, the buffer areas are served by the vehicles serving the pier side, wherein said buffer areas are arranged mainly parallel with the pier side serving a number of cranes when loading/unloading containers onboard/off a cargo vessel, and wherein the buffer areas comprising a number of passages for the vehicles serving the pier side.

10. Container terminal according to claim 7, wherein the pier side comprising a number of lanes for the vehicles serving the pier side enabling communication between the land side and the pier side, wherein the lanes are arranged encircling the buffer areas.

11. Container terminal according to claim 6, wherein the modularized storage system is connected to the truck interface and the railway interface, and wherein the modularized service floor comprising at least one infeed and at least one outfeed conveyor system for the at least one modularized elevator serving the modularized storage system, enabling communication between the modularized storage system and the pier side and the land side of the terminal.

12. Container terminal according to claim 1, wherein the modularized container terminal is prefabricated in modules enabling packaging and transport in ocean ISO containers.

13. An automated modularized vertical storage system for a container terminal, the automated modularized vertical storage system comprising:
a number of modularized storage blocks, wherein each storage block is served by at least one modularized elevator, wherein each modularized storage block comprising:
at least one modularized storage module for storing ocean ISO containers on standardized cargo load platforms in slots in the modularized storage module, wherein each slot providing at least one storage position in a horizontal direction and at least one storage position in a vertical direction, wherein the modularized storage module comprising a plurality of modularized vertical columns having a plurality of receiving means/receptacles adapted for engaging cargo load platforms, wherein the plurality of receiving means/receptacles are arranged in a predefined vertical pattern along the modularized vertical columns corresponding to a number of storage positions for a number of containers stored on a number of cargo load platforms, wherein a number of the receiving means/receptacles are provided with roller conveyors providing random access storage in at least some of the slots of the modularized storage module for the cargo load platforms; and
a number of cargo trolleys for transport of cargo load platforms within the automated modularized vertical storage system, wherein each cargo trolley comprising a wheel arrangement enabling longitudinal and transversal movement of the cargo trolley, and a lifting platform for transporting a cargo load platform, wherein the lifting platform is provided with roller conveyors for transfer of cargo load platforms and containers to and from roller conveyors arranged in the modularized storage module.

14. Modularized storage system according to claim 13, wherein the modularized storage modules are vertically stackable on top of each other.

15. Modularized storage system according to claim 13, wherein the modularized vertical columns are vertically extendable in modular steps, each modular step forming a level in the modularized storage block, each level comprising at least one distribution aisle serving the at least one modularized storage module; and
the at least one modularized elevator comprising modularized vertical elevator columns extendable in modular steps, wherein a height of the modularized vertical elevator columns is adapted to a number of modularized storage modules stacked on top of each other.

16. Modularized storage system according to claim 13, wherein a first modularized storage volume is arranged between two parallel distribution lanes, and wherein a second and a third modularized storage volume are arranged on an outside of the two parallel distribution lanes.

17. Modularized storage system according to claim 13, wherein the plurality of modularized vertical columns defines a number of slots.

18. Modularized storage system according to claim 1, wherein the wheel arrangement comprising a first set of a wheel arrangement for running in the longitudinal direction, and a second set of a wheel arrangement, wherein the second set of wheel arrangement is transversally arranged to the first set of wheel arrangements for transversal transfer of the cargo trolley.

19. Modularized storage system according to claim 13, wherein each of the modularized elevators is provided with at least one buffer area on each level, wherein the at least one buffer area is provided with conveyor means for infeed and outfeed of cargo load platforms.

20. Modularized storage system according to claim 13, wherein the number of storage blocks are arranged side by side.

21. Modularized storage system according to claim 13, further comprising at least one transverse pathway for cargo trolleys between the number of modularized storage blocks enabling deployment of cargo trolleys to any distribution aisle in any of the modularized storage blocks.

22. Modularized storage system according to claim 21, wherein the at least one transverse pathway is provided by roller conveyors running through parallel slots in a level throughout the number of storage blocks.

23. Modularized storage system according to claim 13, wherein the height of each slot corresponds to at least a maximum lifting height of a cargo trolley adapted for transporting the cargo load platforms.

24. Modularized storage system according to claim 13, further comprising a maintenance and holding area arranged adjacent to the modularized storage system for the cargo trolleys serving the modularized storage system.

25. Modularized storage system according to claim 13, further comprising at least one distribution lane serving the slots, the at least one distribution lane is provided with modularized longitudinal rails for the cargo trolley serving the slots.

26. Modularized storage system according to claim 17, wherein the slots are arranged transverse of the distribution lane and wherein each slot is provided with modularized rails transverse to the modularized longitudinal rails in the distribution lane adapted for side transfer of the cargo trolley and cargo load platforms into and out of the slot.

27. Modularized storage system according to claim 13, further comprising modularized power supply rails for power supply to cargo trolleys serving the slots.

28. Modularized storage system module according to claim 13, wherein the modularized vertical columns are horizontally connected by modularized longitudinal beams and modularized transverse beams, wherein modularized longitudinal beams supporting modularized longitudinal rails in at least one distribution lane and the modularized transverse beams supporting transverse rails in the slots.

29. Modularized storage system according to claim 13, wherein a base size of each storage position in the horizontal direction in each slot and a base size of each cargo load platform correspond to a base size of a FEU footprint, and wherein each cargo load platform are provided with locking means for engaging the receiving means/receptacles enabling support of the cargo load platforms as close to the vertical modular columns as possible.

30. Modularized storage system according to claim 13, wherein the receiving means/receptacles are provided with conical guides for positioning of the locking means.

31. A cargo trolley for transporting a cargo load platform in a modularized storage system, the cargo trolley comprising:
a chassis with a wheel arrangement enabling longitudinal and transversal movement of the cargo trolley,
a lifting platform for transporting the cargo load platform, wherein the lifting platform is provided with roller conveyors for transfer of cargo load platforms and containers to and from roller conveyors arranged in slots in the modularized storage system; and
a lifting mechanism for lifting and lowering the lifting platform.

32. Cargo trolley according to claim 31, wherein the wheel arrangement comprising a first set of a wheel arrangement for running in the longitudinal direction, and a second set of a wheel arrangement, wherein the second set of wheel arrangement is transversally arranged to the first set of wheel arrangement for transversal transfer of the cargo trolley.

33. Cargo trolley according to claim 31, further comprising:
a mechanical connector arranged in the lifting platform, the mechanical connector being provided with drive means adapted to fold or unfold legs on the underside of the cargo load platform, and
an actuating mechanism arranged in the lifting platform for extending and retracting a locking mechanism located in the cargo load platform for engaging and disengaging the cargo load platform with the modularized vertical columns of the modularized storage system.

34. Container terminal comprising:
an automated modularized vertical storage system for storing ocean ISO containers on standardized cargo load platforms, the automated modularized vertical storage system comprising a number of modularized storage modules stacked vertically on top of each other forming a modularized block, wherein a number of modularized blocks are arranged side by side forming the automated modularized vertical storage system.

35. An automated modularized vertical storage system for a container terminal, the automated modularized vertical storage system comprising:
a number of modularized storage blocks, wherein each storage block is served by at least one modularized elevator, wherein each modularized storage block comprising:
at least one modularized storage module for storing ocean ISO containers on standardized cargo load platforms, wherein the modularized storage module comprising a plurality of modularized vertical columns having a plurality of receiving means/receptacles adapted for engaging the cargo load platforms, wherein the plurality of receiving means/receptacles are arranged in a predefined vertical pattern along the modularized vertical columns corresponding to a number of storage positions for a number of containers stored on a number of cargo load platforms.
